(19) United States
(12) Patent Application Publication
(10) Pub. No.: US 2024/0222803 A1
(43) Pub. Date: Jul. 4, 2024

(54) TEXTURED ELECTRODE TAB

(71) Applicant: Rivian IP Holdings, LLC, Plymouth, MI (US)

(72) Inventors: Prathamesh Bilgunde, Sunnyvale, CA (US); Arvinth Chandar Rathinam, Sunnyvale, CA (US); Susheel Teja Gogineni, Sunnyvale, CA (US)

(21) Appl. No.: 18/147,293

(22) Filed: Dec. 28, 2022

(51) Int. Cl. H01M 50/533

(52) U.S. Cl. CPC H01M 50/533

(57) ABSTRACT

The present disclosure is related to a battery cell. The battery cell can include a current collector. The battery cell can include a first electrode tab having a textured surface. The first electrode tab can be electrically coupled with the current collector.

### INTRODUCTION

A battery can be used to operate a vehicle or components thereof.

### SUMMARY

A battery cell can include an electrode having an electrode tab (e.g., an electrically conductive foil, such as a copper foil, an aluminum foil, or a tab of some other conductive material) to electrically couple the electrode with some other object (e.g., another electrode, a current collector, a terminal, or some other component). The electrode tab can be, or include, a textured surface. The battery cell can include multiple electrodes, where an electrode tab of each of the multiple electrodes are joined to form an electrode stack tab. The electrode stack tab can include a textured surface. For example, the uppermost electrode tab, the lowermost electrode tab, multiple electrode tabs, or every electrode tab of the electrode stack tab can include a textured surface. The textured surface can facilitate an electrical coupling of the electrode tab or the electrode stack tab to a current collector or other object (e.g., a conductive element, a battery cell terminal, an electrode stack tab of another electrode stack). The textured surface can reduce spatter during a subsequent joining operation (e.g., a laser welding operation) to join the electrode tab or the electrode stack tab with a current collector or other object (e.g., an electrode stack tab of another electrode stack). The textured surface can improve absorption or an incident beam (e.g., a laser beam) during the joining operation (e.g., a laser welding operation) to bolster the integrity of a welded joint between the electrode tab or the electrode stack tab and a current collector or other object. The textured surface can have an increased surface area relative to an un-textured surface and can improve thermal behavior of the battery cell. The textured surface can be created by an ultrasonic welder, a micro-machining device, or some other device. The textured surface can be a random texture, a patterned texture, a texture that varies along a direction of the electrode tab, or some other texture. The current collector can include a textured surface. The textured surface of the current collector can facilitate a joining of the current collector to an electrode tab or an electrode stack tab. For example, the textured surface of the current collector can interlock (e.g., micro wedge locking) with a textured surface of the electrode tab, the electrode stack tab, or another object to increase a strength of a joint formed between the electrode tab or electrode stack tab and the current collector.

At least one aspect is directed to an apparatus. The apparatus can be a battery cell. The battery cell can include a current collector. The battery cell can include a first electrode tab having a textured surface. The first electrode tab can be electrically coupled with the current collector.

At least one aspect is directed to a method. The method can include providing a first electrode tab having a textured surface. The method can include electrically coupling the first electrode tab to a current collector.

At least one aspect is directed to a system. The system can be a structural battery pack. The structural battery pack can include a battery cell. The battery cell can include a structural member. The battery cell can include a first electrode tab having a textured surface. The first electrode tab can be partially enclosed by the structural member.

At least one aspect is directed to an electric vehicle. The electric vehicle can include a battery cell. The battery cell can include a current collector. The battery cell can include a first electrode tab having a textured surface. The first electrode tab can be electrically coupled with the current collector.

At least one aspect is directed to a method. The method can include providing a battery cell. The battery cell can include a current collector. The battery cell can include a first electrode tab having a textured surface. The first electrode tab can be electrically coupled with the current collector.

At least one aspect is directed to a method. The method can include providing a battery pack. The battery pack can be a structural battery pack. The structural battery pack can include a battery cell. The battery cell can include a structural member. The battery cell can include a current collector. The battery cell can include a first electrode tab having a textured surface. The first electrode tab can be electrically coupled with the current collector.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example battery cell, in accordance with some aspects.

FIG. 2 depicts an example battery electrode having a textured surface joined with a current collector, in accordance with some aspects.

FIG. 3 depicts an example battery electrode having at least one textured surface joined with a current collector having a textured surface, in accordance with some aspects.

FIG. 4 depicts an example battery electrode having a textured surface, in accordance with some aspects.

FIG. 5 depicts an example textured surface of for an electrode tab of a battery electrode, in accordance with some aspects.

FIG. 6 depicts an example textured surface of for an electrode tab of a battery electrode, in accordance with some aspects.

FIG. 7 depicts an example textured surface of for an electrode tab of a battery electrode, in accordance with some aspects.

FIG. 8 depicts an example textured surface of for an electrode tab of a battery electrode, in accordance with some aspects.

FIG. 9 depicts an example textured surface of for an electrode tab of a battery electrode, in accordance with some aspects.

FIG. 10 depicts an example textured surface of for an electrode tab of a battery electrode, in accordance with some aspects.

FIG. 11 depicts an example textured surface of for an electrode tab of a battery electrode, in accordance with some aspects.

FIG. 12 depicts an example textured surface of for an electrode tab of a battery electrode, in accordance with some aspects.

FIG. 13 depicts an example electrode stack, in accordance with some aspects.

FIG. 14 depicts an example process flow for creating a battery electrode, in accordance with some aspects.

FIG. 15 is a flow chart of an example method of manufacturing a battery cell, in accordance with some aspects.

FIG. 16 depicts an example electric vehicle, in accordance with some aspects.

FIG. 17 depicts an example battery pack, in accordance with some aspects.

FIG. 18 depicts an example battery module, in accordance with some aspects.

FIG. 19 depicts a cross sectional view of an example battery cell, in accordance with some aspects.

FIG. 20 depicts a cross sectional view of an example battery cell, in accordance with some aspects.

FIG. 21 depicts a cross sectional view of an example battery cell, in accordance with some aspects.

FIG. 22 is a flow chart of an example method of providing a battery cell, in accordance with some aspects.

FIG. 23 is a flow chart of an example method of providing a battery pack, such as a structural battery pack, in accordance with some aspects.

### DETAILED DESCRIPTION

Following below are more detailed descriptions of various concepts related to, and implementations of, methods, apparatuses, and systems of battery cells. The various concepts introduced above and discussed in greater detail below may be implemented in any of numerous ways.

This disclosure is generally directed to a battery cell having an electrode with an electrode tab (e.g., an electrically conductive foil, such as a copper foil, an aluminum foil, or a foil of some other material), to electrically couple the electrode with some other object (e.g., another electrode, a current collector, or some other object). The electrode tab can have a textured surface. The battery cell can include multiple electrodes, and each electrode can include an electrode tab. The multiple electrode tabs can be joined to form an electrode stack tab (e.g., a pre-welded tab) to electrically couple an electrode stack (e.g., a layered electrode stack or a wound electrode stack, such as a jelly roll) with another component (e.g., another electrode stack, a current collector, or other element) of the battery cell or battery pack. The electrode stack tab can be at least one electrode tab from at least one electrode. For example, the electrode stack tab can include multiple electrode tabs from multiple electrode layers that are electrically coupled together. The electrode stack tab can include a textured surface. The textured surface can facilitate an electrical coupling of the electrode stack tab to a current collector or other object (e.g., an electrode stack tab of another electrode stack). For example, the textured surface can reduce spatter during a subsequent joining operation (e.g., a laser welding operation) to join the electrode stack tab with a current collector or other object (e.g., a tab of another electrode stack). The textured surface can improve absorption or an incident beam (e.g., a laser beam) during the joining operation (e.g., a laser welding operation) to bolster the integrity of a welded joint between the tab and a current collector or other object. The textured surface can have an increased surface area relative to an un-textured surface and can improve thermal behavior of the battery cell. For example, the textured surface can improve (e.g., increase) a rate of heat dissipation compared to an un-textured electrode tab with the surface area of the textured surface being greater than a surface area of an un-textured electrode tab. The improved rate of heat dissipation can prevent or reduce undesirably high temperatures within a battery cell, for example.

Multiple electrode tabs can be joined (e.g., electrically coupled) to form the electrode stack tab. For example, multiple electrode tabs can be joined via an ultrasonic welding operation to form the electrode stack tab. An ultrasonic welder can create a texture on a surface of the electrode stack tab (e.g., a surface of an uppermost electrode tab of the multiple electrode tabs joined to form the electrode stack tab) to create the textured surface. The ultrasonic welder can create various textures, including patterned textures, random textures, relatively coarse textures, relatively fine textures, or some combination thereof. The textured surface can be created during one or more upstream processes of electrode manufacturing. For example, the textured surface can be created during an electrode coating operation whereby a dry, semi-dry, semi-wet, wet electrode material can be applied to (e.g., laminated with, adhered to, joined with) an electrically conductive foil layer. The electrically conductive foil layer can be micro-machined, etched, or otherwise texturized to create a textured surface of the electrically conductive foil layer. The textured foil layer can subsequently be notched (e.g., cut or trimmed) to form the electrode tab of the electrode, where the electrode tab can electrically couple the electrode with another electrode to form the electrode stack tab. One or more electrode tabs of the electrode stack tab can include the textured surface. For example, each electrode tab of an electrode stack tab can include a textured surface. A top surface of each electrode tab, a bottom surface of each electrode tab, the top and bottom surfaces of each electrode tab, or some other combination of surfaces of multiple electrode tabs can include the textured surface. The textured foil layer (e.g., a foil layer with texture applied to the foil layer prior to a notching operation) can improve bending stiffness of the foil layer to improve the integrity of the foil layer during other processes of electrode manufacture (e.g., stacking, notching, calendaring, or other processes).

The current collector can include a textured surface. For example, the current collector can be micro-machined, etched, or otherwise texturized to include a textured surface. The textured surface of the current collector can facilitate a joining of the current collector to an electrode tab or an electrode stack tab. For example, the textured surface of the current collector can interlock (e.g., micro wedge locking) with a textured surface of the electrode tab, the electrode stack tab, or another object. An interlocking or other interaction between the textured surface of the current collector and the electrode tab or the electrode stack tab can increase the resultant strength (e.g., integrity, shear strength, resilience) a joint (e.g., a welded joint) created by joining the tab with the current collector. The battery cell including the textured surface can be a structural battery cell, a prismatic battery cell, a cell-to-pack (blade battery), a solid-state battery, a cylindrical battery cell, a pouch battery cell, or a battery cell having some other form factor. For example, the battery cell can be a structural battery cell where an increased strength of a joint between the electrode tab or the electrode stack tab and the current collector can bolster an integrity of the structural battery cell or can reduce a likelihood of separation between the tab and the current collector over time.

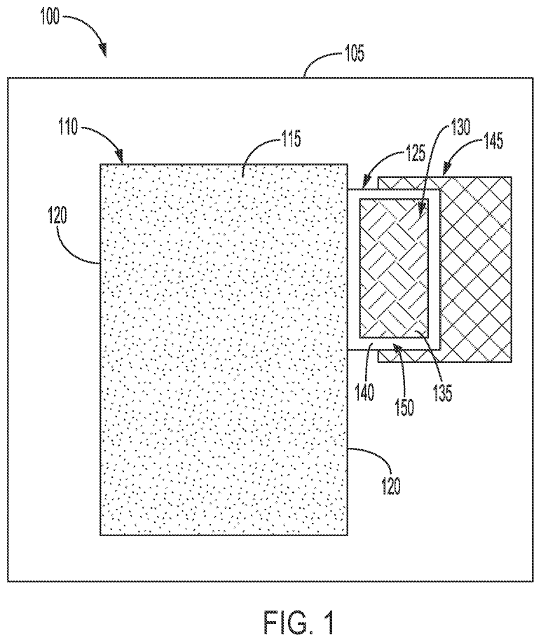

FIG. 1, among others, depicts an example battery cell 100. The battery cell 100 can include a housing 105, at least one electrode 110, and at least one current collector 145. For example, the electrode 110 can include at least one battery active material layer 115, at least one side 120, an electrically conductive foil layer 125, and an electrode tab 130. The electrode 110 can include at least one battery active material layer 115 joined with the electrically conductive foil layer 125. For example, the electrode 110 can include a first battery active material layer 115 joined with (e.g., laminated to, coated on, adhered to) a first side of the electrically conductive foil layer 125 and a second battery active material layer 115 joined with (e.g., laminated to, coated on, adhered to) a second side of the electrically conductive foil layer 125. The battery active material layer 115 can be or include an anode active material or a cathode active material. For example, the electrode 110 can be an anode electrode with a first battery active material layer 115 having an anode chemistry coated on a top of the electrically conductive foil layer 125 and a second battery active material layer 115 having an anode chemistry coated on a bottom of the electrically conductive foil layer 125.

The electrically conductive foil layer 125 can be coupled with (e.g., integrated with, continuous with, joined with) the electrode tab 130. For example, the electrode tab 130 can be a portion of the electrically conductive foil layer 125 that is not coated with (e.g., covered by, disposed between) one or more battery active material layers 115. The electrode tab 130 can be an uncoated portion of the electrically conductive foil layer 125 that extends to at least one side of the electrode 110. For example, the electrode tab 130 can extend from the side 120 of the electrode 110. The electrode tab 130 can extend from a side of the electrode 110 to electrically couple the electrode 110 (e.g., the electrically conductive foil layer 125 of the electrode 110) and some other object, such as a current collector (e.g., the current collector 145), at least one other electrode 110, or some other object.

The electrode tab 130 can be a portion of an electrically conductive foil layer 125 of the electrode 110 that extends from (e.g., protrudes from) at least one side 120 of the electrode 110. The electrode tab 130 can be an uncoated portion of the electrically conductive foil layer 125. For example, the electrode tab 130 can be a portion of the foil layer 125 that is not coated with (e.g., laminated with, adhered to, joined with) a battery active material layer 115 of the electrode 110. The electrode tab 130 can be continuous with (e.g., integrated with, a part of) the electrically conductive foil layer 125 of the electrode 110. For example, the electrode tab 130 can be a remaining portion of the foil layer 125 that is not coated with battery active material layer 115 during production of the electrode 110 and after the uncoated portions of the foil layer 125 are notched to create the electrode tab 130 with other portions (e.g., a scrap portion, a discarded portion, an unused portion) of the foil layer 125 removed.

The battery cell 100 can include the electrode tab 130 having a textured surface 135. For example, the first surface 150 of the electrode tab 130 can include the textured surface 135. The textured surface 135 can be a portion of the first surface 150 of the electrode tab 130 that includes a surface texture that is rough relative to a remainder of the electrode tab 130 or relative to the electrically conductive foil layer 125. For example, the textured surface 135 can include a surface roughness (e.g., an Ra value, an average roughness) that is greater than a surface roughness of the foil layer 125 that has not been texturized. The foil layer 125 can be or include a shiny. smooth, substantially uniform (e.g., ±90% uniform) surface profile in absence of the textured surface 135. The textured surface 135 can instead be or include a rough, matte, or at least partially non-uniform surface.

The battery cell 100 can include the electrode tab 130 including a first surface 150. A portion of the first surface includes the textured surface and a remaining portion of the first surface includes an un-textured surface. For example, the first surface 150 can include the textured surface 135 and an un-textured surface 140. The un-textured surface 140 can be the electrode tab 130 without any texture. For example, the un-textured surface 140 can be or include a smooth surface with a high degree of reflectivity relative to the textured surface 135. The un-textured surface 140 can be the electrode tab 130 (e.g., a portion of the electrically conductive foil layer 125 extending from the side 120 of the electrode 110) without any secondary processing to provide texture.

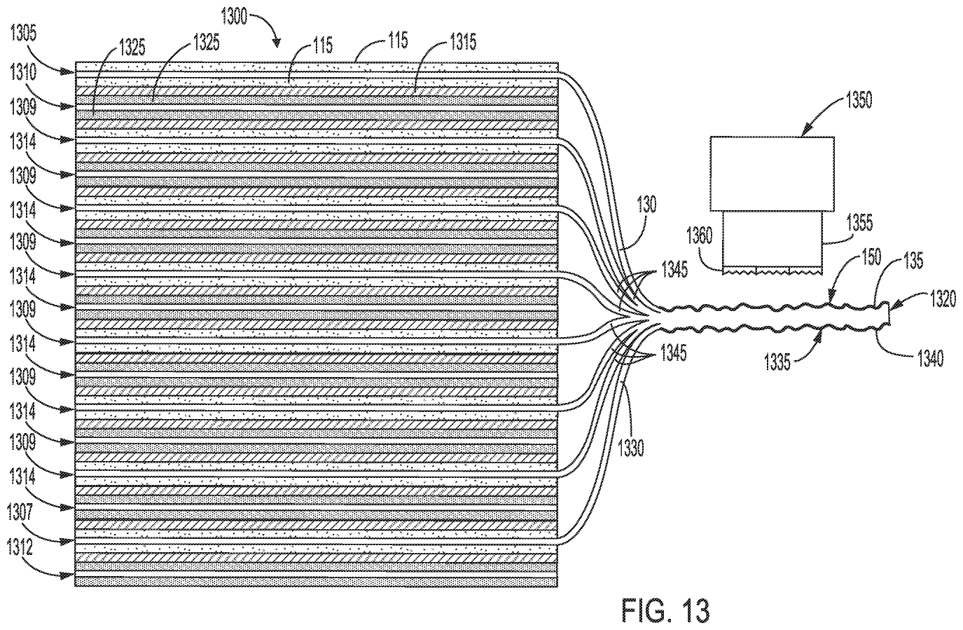

The battery cell 100 can include at least one current collector. For example, the battery cell 100 can include the current collector 145 electrically coupled with the electrode tab 130. The current collector 145 can be an electrically conductive member within the housing 105 of the battery cell 100 that can facilitate an electrical connection between the electrode 110 and some other object (e.g., a battery terminal or an electrode tab). The current collector 145 can be an electrically conductive member of an electrode stack (e.g., a jelly roll for a cylindrical battery cell or an electrode layer stack for a prismatic, pouch, or other cell). For example, the current collector 145 can be an electrode stack tab of an electrode stack (e.g., the electrode stack tab 1320 as is discussed in detail below and shown in FIG. 13, among others). The current collector 145 can be coupled with at least one electrode 110 within the housing and at least one terminal (e.g., a battery cell terminal), where the terminal can be accessed outside of the housing 105 of the battery cell 100. The current collector 145 can include a material composition that corresponds to a polarity of an electrode 110 with which the current collector 145 can be coupled. For example, the current collector 145 can be or include a copper material with the current collector 145 coupled with one or more anode electrodes 110 (e.g., an electrode 110 including an anode battery active material 115, a copper electrically conductive foil layer 125, and a copper electrode tab 130). The current collector 145 can be or include an aluminum material with the current collector 145 coupled with one or more cathode electrodes 110 (e.g., an electrode 110 including a cathode battery active material 115, an aluminum electrically conductive foil layer 125, and an aluminum electrode tab 130).

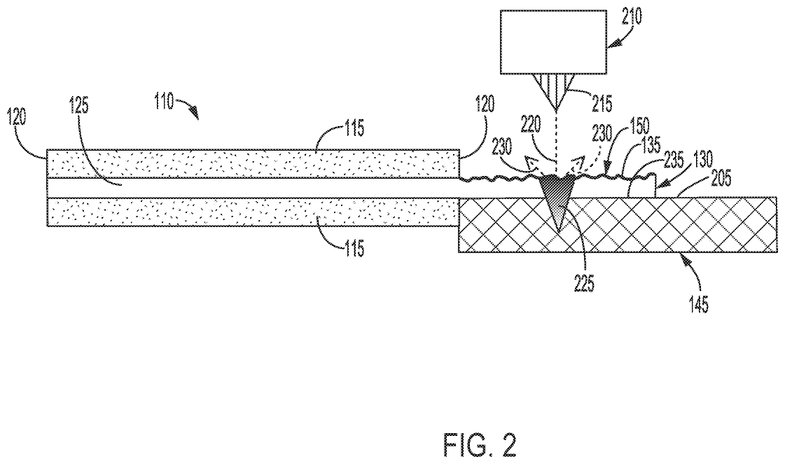

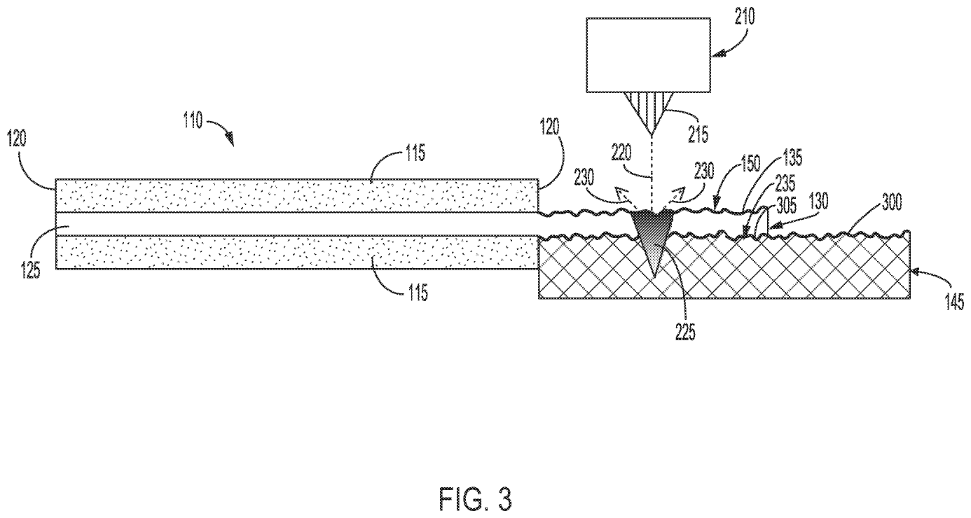

As depicted in FIGS. 2-3, among others, the electrode 110 of the battery cell 100 can include the electrode tab 130 having a second surface 235. For example, the second surface 235 of the electrode tab 130 can be a lowermost surface of the electrode tab 130 while the first surface 150 of the electrode tab 130 can be an uppermost surface of the electrode tab 130. As depicted in FIG. 3, among others, the second surface 235 of the electrode tab 130 can include a second textured surface 305. The second textured surface 305 can be a portion of the second surface 235 of the electrode tab 130 that includes a surface texture that is rough relative to a remainder of the electrode tab 130 or relative to the electrically conductive foil layer 125. For example, the second textured surface 305 can include a surface roughness (e.g., an Ra value, an average roughness) that is greater than a surface roughness of the foil layer 125 that has not been texturized. The foil layer 125 can be or include a shiny, smooth, substantially uniform (e.g., ±90% uniform) surface profile in absence of the textured surface 135. The second textured surface 305 can instead be or include a rough, matte, or at least partially non-uniform surface.

As depicted in FIGS. 2-5, among others, the first electrode tab 130 of the battery cell 100 can be electrically coupled with the current collector 145. For example, the electrode tab 130 can be electrically coupled with the current collector 145 such that electricity can flow from the electrode tab 130 (e.g., from the electrode 110 or from multiple electrodes) to the current collector 145 or vice versa. The electrode tab 130 can electrically couple the electrode 110 with another object. For example, the electrode tab 130 can electrically couple the electrode 110 with the current collector 145. The current collector 145 can be an electrically conductive member to provide for electrical coupling of the electrode 110 with a terminal of the battery cell 100, at least one other electrode 110, or otherwise. For example, the electrode tab 130 can include a material that corresponds to a material of the current collector 145 to facilitate a coupling (e.g., mating, joining, welding) of the current collector 145 with the electrode tab 130. The electrode tab 130 can include a copper material with the electrode 110 including an anode battery active material layer 115 to couple with a current collector 145 having a copper material. The electrode tab 130 can include an aluminum material with the electrode 110 including a cathode battery active material layer 115 to couple with a current collector 145 having an aluminum material.

As depicted in FIG. 2, among others, the electrode tab 130 can include the first surface 150 and the second surface 235. The current collector can include a first surface 205. For example, the electrode tab 130 can include the second surface 235 (e.g., a lowermost or bottom surface) to contact the first surface 205 of the current collector 145 with the electrode tab 130 directly coupled (e.g., without any other intervening electrode tabs) with the current collector 145. The first surface 150 (e.g., an upper surface) can be exposed (e.g., visible, accessible, out-ward facing) with the electrode tab 130 directly coupled with the current collector 145. For example, the second surface 235 of the electrode tab 130 can be positioned against (e.g., abut, touch, contact, mate with) the surface 205 of the current collector 145 with the electrode tab 130 electrically coupled with the current collector 145 while the first surface 150 of the electrode tab 130 can face away from the current collector, as depicted in FIG. 2, among others. The first surface 150 can be or include the textured surface 135 and the second surface 235 can be or include the textured surface 305.

As depicted in FIGS. 2-5, among others, the battery cell 100 can include the electrode tab 130 laser-welded with the current collector 145 to electrically couple the electrode tab 130 with the current collector 145. For example, the electrode tab 130 can be laser welded to the current collector 145 by at least one laser welding device 210. The laser welding device 210 can be a green laser welding device (e.g., emitting light having a wavelength of 532 nm or light at some other wavelength), an infrared (IR) laser welding device (e.g., emitting light having a wavelength of 1064 nm or light at some other wavelength), or some other laser welding device. The laser welding device 210 can emit a laser to weld the electrode tab 130 to the current collector 145 to electrically couple the electrode tab 130 to the current collector 145. As depicted in FIGS. 2-3, among others, the laser welding device 210 can include a laser element 215 to emit at least one laser 220 (e.g., a laser beam). The laser element 215 can emit a laser 220 towards the electrode tab 130. For example, the laser element 215 can emit the laser 220 towards the textured surface 135 of the electrode tab 130. The laser element 215 can emit the laser 220 directly perpendicular to the electrode tab 130 or at some angle (e.g., 45 degrees, 30 degrees, or some other angle) with respect the electrode tab 130.

The laser welding device 210 can emit the laser 220 towards the electrode tab 130 to create a joint 225. The joint 225 can be a welded joint that joins (e.g., mechanically couples, welds, fuses, or otherwise mates) the electrode tab 130 with the current collector 145. For example, the electrode tab 130 can be physically joined with the current collector 145 such that the current collector 145 cannot be separated from the electrode tab 130 without damaging or destroying one of the current collector 145 and the electrode tab 130. The joint 225 can include a melding, melting, combining, or blending of the current collector 145 with the electrode tab 130 or with multiple electrode tabs (e.g., an electrode stack tab 1320, as shown in FIG. 13). For example, the laser 220 emitted by the laser element 215 of the laser welding device 210 can cause a portion of the electrode tab 130 and a portion of the current collector 145 to melt and combine to form the joint 225. The laser 220 can include sufficient energy to cause at least a portion of the electrode tab 130 and at least a portion of the current collector 145 to melt, where the joint 225 can be formed via the melting of a portion of the electrode tab 130 and at least a portion of the current collector 145 with the electrode tab 130 against the current collector 145. For example, the surface 235 of the electrode tab 130 can be positioned against (e.g., abutting, contacting, or touching) the first surface 205 or some other surface of the current collector 145. A portion of the first surface 205 of the current collector 145 and the second surface 235 that is contacting (e.g., abutting, touching, positioned against) the first surface 205 can melt or partially melt to form the joint 225.

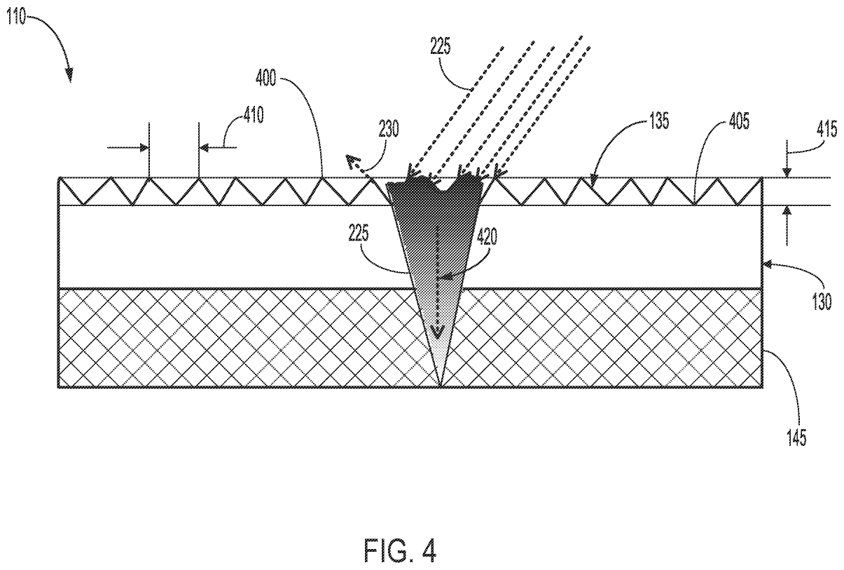

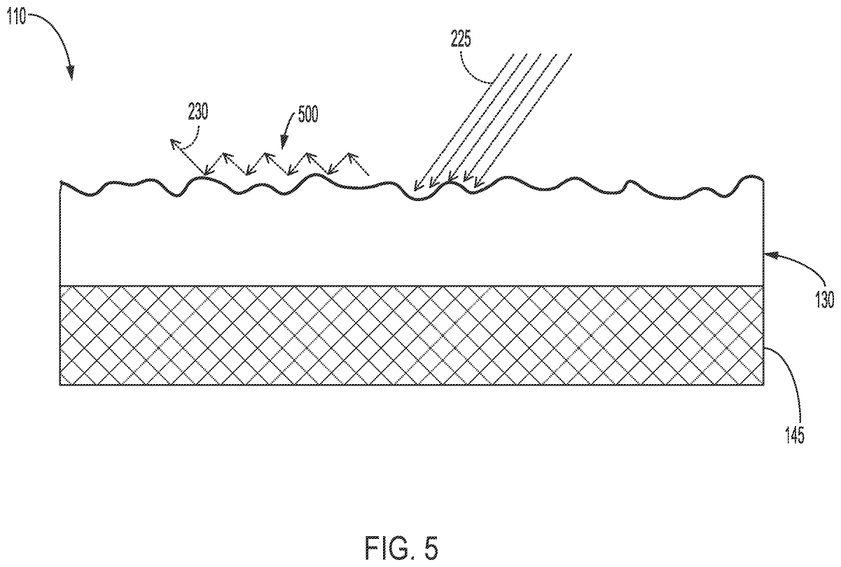

The battery cell 100 can include the first electrode tab having the textured surface 135 to facilitate an electrical coupling of the electrode tab 130 with the current collector 145. For example, as depicted in FIG. 4, among others, the textured surface 135 of the electrode tab 130 can facilitate an absorption of the laser 220 to create the joint 225. The laser welding device 210 can include the laser element 215 to emit the laser 220 towards the textured surface 135. The laser 220 can be at least partially absorbed into the electrode tab 130 having the textured surface 135 and the current collector 145 coupled with the electrode tab 130 to create the joint. For example, directing the laser 220 at the textured surface can result in a reflected laser 230 and an absorbed laser 420. As depicted in FIG. 5, among others, a diffused wave field 500 can be created by the textured surface 135. For example, the textured surface 135 can trap the laser 220 or the reflected laser 230 in at least one pattern of the textured surface to create the diffused wave field 500, where the diffused wave field reduces an amount of the laser 220 that is reflected as the reflected laser 230. The textured surface 135 can cause the absorbed laser 420 to be of a greater magnitude or strength (e.g., more energy absorbed) with the laser 220 directed at the textured surface 135 than laser absorbed in an electrode tab or current collector with the laser 220 directed at an un-textured electrode tab (e.g., the un-textured surface 140 of the electrode tab 130). The textured surface 135 can cause the reflected laser 230 to be smaller with the laser 220 directed at the textured surface 135 than a reflected laser resulting from directing the laser 220 at an un-textured electrode tab (e.g., the un-textured surface 140 of the electrode tab 130). For example, the absorbed laser 420 can have a higher energy because less of the laser 220 is reflected as reflected lasers 230 with the electrode tab 130 including the textured surface. Because the absorbed laser 420 can have an increased energy level (e.g., a higher absorption rate), the joint 225 created by laser welding the electrode tab 130 to the current collector 145 can be larger, stronger, deeper (e.g., penetrating the current collector 145 at a greater depth), or more resilient.

The textured surface 135 can increase an absorption of the laser 220 and minimize a reflection of the laser 220 because the textured surface 135 can include an optical impedance tuned to minimize a reflection ratio, so that a greater proportion of the laser 220 is absorbed as the absorbed laser 420 and less is reflected as the reflected laser 230.

For example, transmission of the laser 220 into the electrode tab 130 and the current collector 145 can be increased with the electrode tab 130 including the textured surface 135. A reflection ratio R can be calculated by the formula:

$$R = \frac{{Z}_{2} - {Z}_{1}}{{Z}_{2} + {Z}_{1}} ,$$

where Z₁ represents an optical impedance of an environment above the textured surface 135 and Z₂ can represent an optical impedance of the textured surface 135 or a sum of an optical impedance of the textured surface 135 and an optical impedance of the electrode tab 130 beneath the textured surface 135. The reflection ration can be minimized by creating the textured surface 135 to have an optical impedance to match or approximately match an optical impedance of an environment above the textured surface 135 (e.g., air). For example, the environment above the textured surface 135 during a welding operation can include a first optical impedance, the textured surface 135 can include a second optical impedance, and a remainder of the electrode tab 130 can include a third optical impedance. The reflection ratio can be minimized with the first optical impedance of air being approximately equal to the sum of the second optical impedance of the textured surface 135 and the optical impedance of the electrode tab 130. The optical impedance of the textured surface 135 can be greater than an optical impedance of an un-textured electrode tab (e.g., the un-textured surface 140) to increase an absorption of the laser 220 into the electrode tab 130 and current collector. For example, the textured surface 135 can include an optical impedance that approximately (e.g., ±15%) matches an impedance of air or an environment above the textured surface 135). The textured surface 135 can include at least one peak 400 having a height 415 that is approximately (e.g., ±15%) one quarter of the wavelength of the laser 220 directed by the laser element 215 towards the textured surface 135. The textured surface 135 can include at least one peak 400 having a height 415 that is greater than one quarter of the wavelength of the laser 220 or less than one quarter of the wavelength of the laser 220.

The textured surface 135 can reduce an amount of spatter during a laser welding operation to couple the electrode tab 130 with the current collector 145. For example, a laser welding operation can cause spatter (e.g., dispersion of micro-droplets of copper material) as the laser 220 contacts the electrode tab 130. High temperatures associated with laser welding can cause melted copper or melted aluminum to spatter (e.g., eject, spread, disperse) from a weld pool, where the spatter can damage the battery active material layer 115 of an electrode (e.g., the electrode 110 or another electrode). For example, laser welding a material with a high degree of reflectivity (e.g., a high reflection ratio relative to a reflection ratio of the textured surface 135), can require a large amount of power to attain an adequate energy transmission into the electrode tab 130 to cause the electrode tab 130 to couple with the current collector 145. The large power requirement, particularly in the case of infrared lasers, for example, can cause a temperature of the electrode tab 130 to increase to or near to a melting point of the material of the electrode tab 130 (e.g., copper, aluminum, or otherwise). Because the electrode tab 130 can be heated to or near to its melting point, a melt pool can form on the surface of the electrode tab 130, which can cause spatter.

The textured surface 135 can reduce spatter by increasing the absorption of the laser 220 into the electrode tab 130 as the absorbed laser 420 by correspondingly reducing a reflection of the laser 220 as the reflected laser 230. The electrode tab 130 including the textured surface 135 can be laser welded with the current collector 145 using a laser of a lower intensity that can avoid heating the electrode tab 130 to or near to its melting point, thereby reducing an amount of spatter with an infrared laser or other laser (e.g., a green laser). For example, because more of the laser 220 is absorbed and less is reflected, a melt pool on the surface of the electrode tab 130 can be minimized to reduce a likelihood or an amount of spatter. By reducing spatter, defects can be avoided and complicated tooling (e.g., green lasers) can be omitted from a laser welding operation, for example. In addition to minimizing spatter, the reduced reflection of the laser 220 as the reflected laser 230 can beneficially prevent damage to optics associated with the laser welding device 210, the laser element 215, or otherwise. For example, because the reflected laser 230 is relatively weak compared to a laser reflected from an un-textured electrode tab, optics associated with the laser welding device 210, the laser element 215, or otherwise are less likely to be damaged by the reflected laser 230.

The textured surface 135 can increase a surface area of the electrode tab 130 to improve at least one thermal property of the battery cell 100. For example, the electrode tab 130 can experience an elevated temperature (e.g., retain heat) as electrical current is conducted through the electrode tab 130. The textured surface 135 having a plurality of peaks 400, valleys 405, or other features can include a surface area that is greater than a surface area of an un-textured electrode tab (e.g., the un-textured surface 140). For example, the increased surface area of the textured surface 135 can facilitate dissipation of heat from the electrode tab 130 with the electrode tab 130 conducting electrical energy. The textured surface 135 can improve (e.g., increase) a rate of heat dissipation compared to an un-textured electrode tab with the surface area of the textured surface 135 being greater than a surface area of an un-textured electrode tab. The improved rate of heat dissipation can prevent or reduce undesirably high temperatures within the housing 105 of the battery cell 100 during operation of the battery cell 100.

As depicted in FIG. 4, among others, the textured surface 135 can include at least one peak 400 (e.g., protrusion, point, or other extending member) and at least one valley 405 (e.g., depression, dip, channel, trough, swale, or other indentation). Although depicted as having pointed crests, peaks 400 and valleys 405, the textured surface 135 can include peaks 400 or valleys 405 having a rounded, curved, or other crests. The textured surface 135 can include multiple peaks 400 and multiple valleys 405 to form a textured, uneven, rough, or irregular surface. For example, the textured surface 135 can include multiple peaks 400 with a valley 405 disposed in between adjacent peaks 400. The peaks 400 (or the valleys 405) can be spaced apart by a width 410. For example, the textured surface 135 can include at least one steep peak 400 (e.g., a peak 400 angled upwards from the valley 405 at an angle greater than 45 degrees) and can be spaced apart from an adjacent peak 400 by a first width 410. The textured surface 135 can include at least one shallow peak 400 (e.g., a peak 400 angled upwards from the valley 405 at an angle less than 45 degrees) and can be spaced apart from an adjacent peak 400 by a second width 410. The second width 410 can be greater than the first width 410 such that the width 410 of a textured surface 135 having shallow peaks 400 can be greater than a width 410 of a textured surface 135 having steep peaks 400. The textured surface 135 can include at least one short peak 400 having a first height 415. The textured surface 135 can include at least one tall peak 400 having a second height 415. For example, the first height 415 can be less than the second height 415 such that the tall peaks 400 can be taller than the short peaks 400. The peak 400 and the valley 405 can be terminate (e.g., end, conclude, stop, transition from peak 400 to valley 405 or from valley 405 to peak 400) at a sharp point, a curved surface, a flat plateau, or a surface of some other shape. For example, the peak 400 or valley 405 can include a sharp or pointed geometry. The peak 400 or the valley 405 can included be a rounded or dull geometry. The peak 400 or the valley 405 can include a flat or plateaued geometry. The peak 400 or the valley 405 can include some other geometry. The textured surface 135 can include at least one peak 400 or at least one valley 405 to create a pattern that is periodic or aperiodic with an incident beam (e.g., an incident laser beam). For example, the textured surface 135 can include multiple peaks 400 and multiple valleys 405 to create a surface that is periodic with the incident laser 220 of the laser welding device 210.

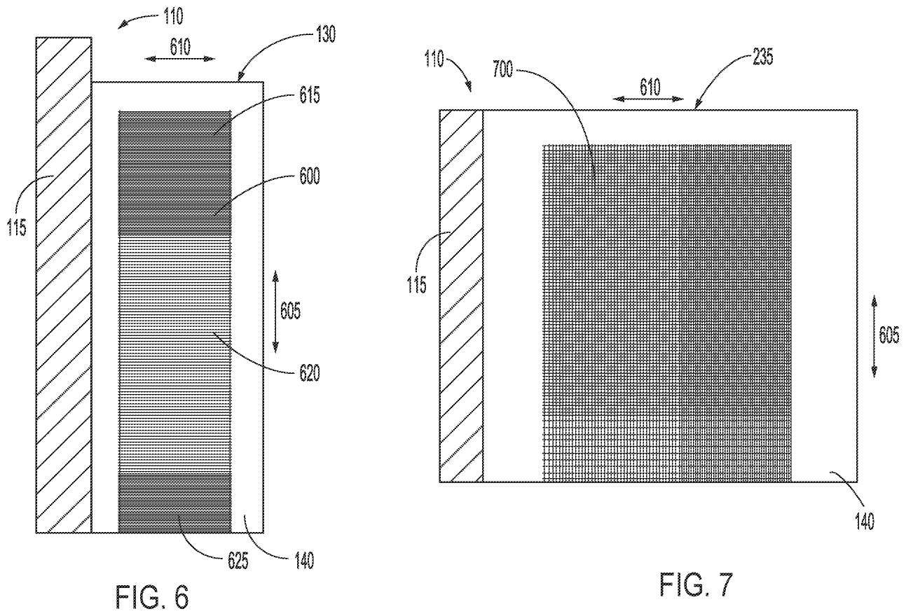

As depicted in FIG. 6, among others, the electrode 110 of the battery cell 100 can include the textured surface 135 including a pattern 600 with a dimension that varies along a direction of the electrode tab 130. For example, the battery cell 100 can include the textured surface having a pattern 600 with a first dimension (e.g., a narrow distance in between peaks 400) in a first section 615 of the tab 130, a second dimension (e.g., a wide distance in between peaks 400) in a second section 620 of the tab 130, and the first dimension (e.g., a narrow distance in between peaks 400) in a third section 625 of the tab 130. The first section 615, the second section 620, the third section 625, or another section can be positioned on the tab 130 along a first direction 605. For example, the pattern 600 can include a dimension that varies along the first direction 605. The textured surface 135 can include multiple peaks 400 or multiple valleys 405, where the peaks 400 or valleys 405 of the pattern 600 can include varying dimensions. For example, the pattern 600 can include a pattern of peaks 400 and valleys 405 including at least one peak 400 of a first dimension (e.g., a steep, tall peak 400) and at least one peak 400 of a second dimension (e.g., a shallow, short peak 400). The peaks 400, valleys 405, or other features of the pattern 600 (or some other pattern) can vary along a first direction 605 (e.g., a length) of the electrode tab 130. For example, the pattern 600 can include peaks 400 or valleys 405 having a first dimension at one position (e.g., end, spot, point, region) of the electrode tab 130 and peaks 400 or valleys 405 having a second dimension at another position (e.g., end, spot, point, region) of the electrode tab 130 along the first direction 605. The peaks 400, valleys 405, or other features of the pattern 600 can vary along a second direction 610 (e.g., a width) of the electrode tab 130. For example, the pattern 600 can include peaks 400 or valleys 405 having a first dimension at one position of the electrode tab 130 and peaks 400 or valleys 405 having a second dimension at another position on the electrode tab 130 along the second direction 610. The peaks 400, valleys 405, or other features of the pattern 600 can vary along some other direction (e.g., direction at some angle with respect to the first direction 605 of the second direction 610) of the electrode tab 130. For example, the pattern 600 can include peaks 400, valleys 405, or other features having a first dimension at one position of the electrode tab 130 and peaks 400 or valleys 405 having a second dimension at another position on the electrode tab 130 along some other direction (e.g., a diagonal line from one corner of the electrode tab 130 to another).

As depicted in FIG. 7 among others, the electrode 110 of the battery cell 100 can include the textured surface 135 having pattern 700 with a dimension that varies along a first direction and a second direction of the electrode tab 130. For example, the textured surface 135 can include multiple peaks 400, multiple valleys 405, or multiple other features. The peaks 400, valleys 405, or other features of the pattern 700 can include varying dimensions. For example, the pattern 700 can include a pattern of peaks 400 and valleys 405 including at least one peak 400 of a first dimension (e.g., a steep, short peak 400) and at least one peak 400 of a second dimension (e.g., a shallow, tall peak 400). The peaks 400, valleys 405, or other features of the pattern 700 (or some other pattern) can vary along the first direction 605 (e.g., a length) of the electrode tab 130. For example, the pattern 700 can include peaks 400 or valleys 405 having a first dimension at one position (e.g., end, spot, point, region) of the electrode tab 130 and peaks 400 or valleys 405 having a second dimension at another position (e.g., end, spot, point, region) of the electrode tab 130 along the first direction 605. The peaks 400, valleys 405, or other features of the pattern 700 can vary along the second direction 610 (e.g., a width) of the electrode tab 130 with the peaks 400, valleys 405, or other features also varying along the first direction 605. For example, the pattern 700 can include peaks 400 or valleys 405 having a first dimension at one position of the electrode tab 130 and peaks 400 or valleys 405 having a second dimension at another position on the electrode tab 130 along the second direction 610. The pattern 700 can include the peaks 400, valleys 405, or other features that vary along any two directions other than or including the first direction 605 and the second direction 610.

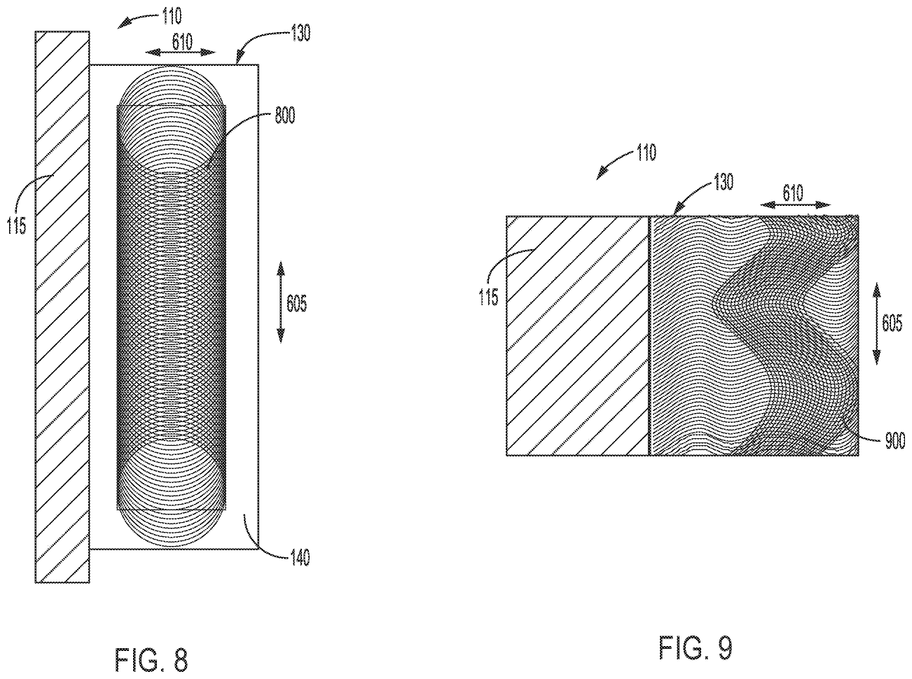

As depicted in FIG. 8, among others, the electrode 110 of the battery cell 100 can include the textured surface 135 having a pattern 800 with a multiple overlapping features. For example, the textured surface 135 can include a pattern 800 including multiple circles overlapping in a first direction. The textured surface 135 can include overlapping features, where the overlapping features can be circular, ovular, round, elliptical, or otherwise curved shapes. The overlapping features can be square, rectangular, triangular, parallelogram, trapezoidal, or some other shape. The overlapping features can have a uniform dimension or a varying dimension. The overlapping features can overlap along at least one direction of the electrode tab 130. For example, the overlapping features can overlap along the first direction 605, the second direction 610, or some other direction of the electrode tab 130. The overlapping features can overlap in a regular or irregular sequence or at a regular or irregular rate. For example, the overlapping features can be positioned uniformly along the electrode tab 130 (e.g., a uniform distance between adjacent overlapping features) or positioned irregularly along the electrode tab 130 (e.g., an irregular distance between adjacent overlapping features).

As depicted in FIG. 9, among others, the electrode 110 of the battery cell 100 can include the textured surface 135 can include a pattern 900 with at least one curvilinear line. For example, the pattern 900 of the textured surface 135 can be a randomized pattern of curved lines or a uniform pattern of curved lines. The pattern 900 can include curved lines extending in the first direction 605 and curved lines extending in the second direction 610. The pattern 900 can include curved lines extending in one direction (e.g., the first direction 605, the second direction 610, or some other direction). The pattern 900 can include curved lines taking a sinusoidal shape, an irregularly curved shape, or some other curved shape. The pattern 900 can include curved lines having a flowing pattern. Each of multiple curved lines of the pattern 900 can be evenly spaced or irregularly spaced from an adjacent feature. The pattern 900 can include the curved lines crossing each other. The pattern 900 can include multiple curved lines in parallel, converging towards each other, or diverging from each other. The pattern 900 can include two or more curved lines originating from (e.g., extending from) the same point or from different points on the electrode tab 130.

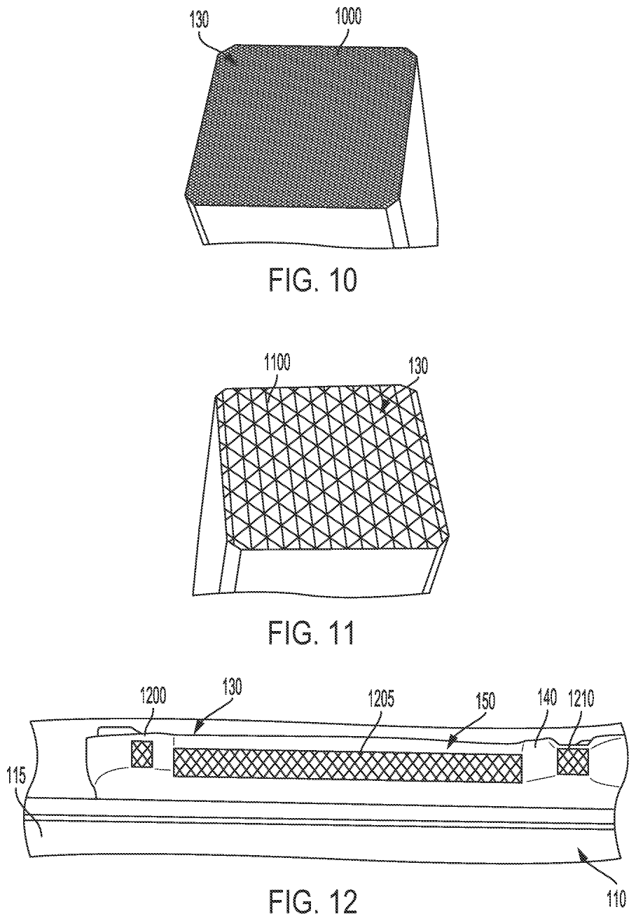

The battery cell 100 can include the electrode tab 130 having the textured surface 135, where the textured surface can include some other pattern. For example, the textured surface 135 can include one or more of the patterns 600, 700, 800, 900, or some other pattern. The textured surface 135 can include a knurled pattern. For example, the textured surface 135 can include a knurled pattern 1000, as depicted in FIG. 10, among others. The knurled pattern 1000 can include relatively small knurling (e.g., less than one millimeter in size, less than two millimeters in size, less than ten millimeters in size, or some other size). The textured surface 135 can include a knurled pattern 1100, as depicted in FIG. 11, among others. The knurled pattern 1100 can include a relatively large knurling (e.g., greater than one millimeter, greater than two millimeters, greater than ten millimeters, or some other size). The knurled pattern 1000 or the knurled pattern 1100 can be a square, diagonal, diamond, or some other knurled shape. The knurled patterns 1000 or 1100 can include a constant (e.g., regular) pitch, or a variable (e.g., irregular) pitch.

The textured surface 135 can include some combination of the patterns 600, 700, 800, 900, 1000, 1100, or some other pattern. For example, the textured surface 135 can include the pattern 800 having a plurality of overlapping features (e.g., circular features) and the pattern 900 (e.g., curved line features). The textured surface 135 can include a first pattern overlapping a second pattern (e.g., circular features overlapped with curved lines). The textured surface 135 can include a first pattern and a second pattern with the first pattern not overlapping the second pattern. For example the textured surface 135 can have a first portion or region (e.g., a portion or region of the electrode tab 130) including the first pattern and a second portion or region including a second pattern, where the first portion or region is separate from (e.g., spaced apart from) the second portion or region.

As depicted in FIG. 12, among others, the electrode 110 of the battery cell 100 can include the electrode tab 130 can having one or more textured surfaces. For example, the first surface 150 can include multiple textured surface portions where one or more of the multiple textured surface portions can be separate or distinct from another textured surface portion. The first surface 150 can have a first textured surface 1200, a second textured surface 1205, and a third textured surface 1210. The first surface 150 can include the un-textured surface 140 between adjacent textured surfaces 1200, 1205, 1210. The first textured surface 1200, the second textured portion 1205, and the third textured portion 1210 can include a similar texture pattern or a different texture pattern. The first textured surface 1200, the second textured portion 1205, and the third textured portion 1210 can be of a similar or different size or dimension. For example, the second textured portion 1205 can be larger than the first textured portion 1200 or the third textured portion 1210.

As depicted in FIG. 3, among others, the current collector 145 can include a textured surface 300. For example, the textured surface 300, like the textured surface 135 and the second textured surface 1340, can be a portion of the surface 205 of the current collector 145 that includes a surface texture that is rough relative to a remainder of the current collector 145. For example, the textured surface 300 can include a surface roughness (e.g., an Ra value, an average roughness) that is greater than a surface roughness of the current collector 145 that has not been texturized. The current collector 145 can be or include a shiny, smooth, substantially uniform (e.g., ±90% uniform) surface profile in absence of the textured surface 300. The textured surface 300 can instead be or include a rough, matte, at least partially non-uniform surface. The textured surface 300 can include at least one peak 400, at least one valley 405, or at least one other feature to provide the surface roughness. For example, the textured surface 300 can include multiple peaks 400, multiple valleys 405, or multiple other features to create the textured surface 300 along a portion of the surface 205. The textured surface 300 can extend along a first direction (e.g., a length), a second direction (e.g., a width), or some other direction of the current collector 145. For example, the textured surface 300 can include at least one of the pattern 600, 700, 800, 900, 1000, 1100 or some other pattern, shape or feature as described above with respect to the textured surface 135. The textured surface 300 can be the surface of the current collector 145 that contacts (e.g., couples against, abuts, touches, is joined with) the electrode tab 130 or with an electrode stack tab (e.g., the electrode stack tab 1320 as shown in FIG. 13 and discussed in detail below) with the electrode tab 130 or the electrode stack tab electrically coupled with the current collector 145.

The battery cell 100 can include the current collector 145 with the current collector 145 including the textured surface 300 to contact the electrode tab 130 or an electrode stack tab (e.g., the electrode stack tab 1300 as depicted in FIG. 13 and as discussed in detail below). The textured surface 300 can contact the electrode tab 130 with the electrode tab 130 coupled with the current collector 145. For example, the battery cell 100 can include the current collector 145 having the textured surface 300 to engage with the electrode tab 130 or with a lowermost tab of an electrode stack tab (e.g., the second electrode tab 1307 as depicted in FIG. 13, among others). The electrode tab 130 can be coupled (e.g., welded, joined, or otherwise coupled) with the current collector 145 to electrically couple the electrode tab 130 with the current collector 145. The textured surface 300 of the current collector 145 can contact (e.g., engage with, touch, mate with) the second surface 235 of the electrode tab 130 or a second electrode tab (e.g., a lowermost electrode tab 130 of the electrode stack 1300, such as the second electrode tab 1307 of FIG. 13) with the electrode tab 130 coupled with the current collector 145.

The textured surface 300 can contact a textured surface of the electrode tab 130. For example, the current collector 145 can include the textured surface 300 in contact with the second textured surface 305 of the electrode tab 130 or a textured lowermost electrode tab of an electrode stack tab (e.g., the textured surface 1335 of the electrode tab 1330, as depicted in FIG. 13, among others). The current collector 145 can include the textured surface 300 in contact with the second textured surface 305 of the electrode tab 130 with the electrode tab 130 electrically coupled with the current collector 145.

The current collector 145 can include the textured surface 300 to increase a strength of the joint 225. For example, the textured surface 300 of the current collector 145 can include a rough surface (e.g., a surface having peaks, valleys, projections, depressions, or other features) that can interact with a rough surface of the textured surface 1340 of the second electrode tab 130. The interaction between the textured surface 300 of the current collector 145 and the textured surface 1340 of the second electrode tab 130 can increase a shear strength of the joint 225. For example, a shear strength of the joint 225 with the textured surface 300 of the current collector 145 interacting with the textured surface 1340 of the second electrode tab 130 can be twice as strong, three times as strong, five times as strong, or some other multiple as strong as a joint between the current collector 145 and an electrode tab 130 where neither the current collector 145 or the electrode tab 130 includes a textured surface.

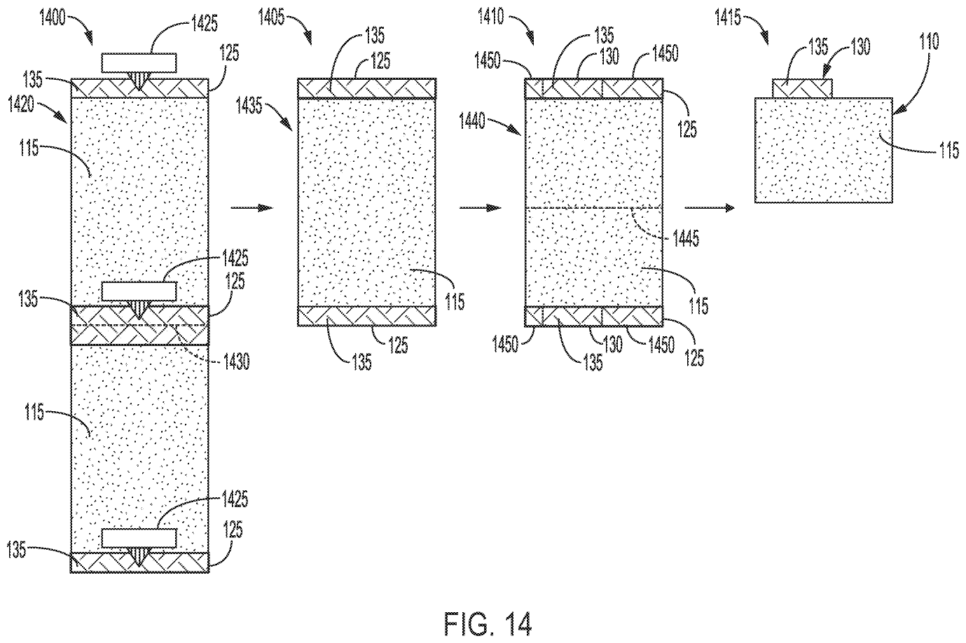

The current collector 145 can include the textured surface 300 applied by a laser device or a micromachining operation. For example, a micromachining device (e.g., an etching machine) or a laser device (e.g., the laser device 1425 depicted in FIG. 14, among others, and described in detail below) can create the textured surface 300 of the current collector 145. The micromachining device or a laser device can machine can cut, chisel, etch, or vaporize material of the current collector 145 to create a textured or non-uniform (e.g., rough) surface of the current collector 145. For example, the textured surface 300 can be created by a laser device that emits a laser beam directed onto a surface of the current collector 145, where the laser beam is a high energy laser beam capable of vaporizing or degrading material on the surface of the current collector 145. An amount of material can be removed from the surface of the current collector 145 to create the textured surface 300. The textured surface 300 of the current collector 145 can have a surface that is rough (e.g., a high Ra or average roughness value) relative to a surface of the current collector that has not been texturized by a micromachining device, a laser device, or otherwise. For example, the textured surface 300 can include a texture that includes multiple peaks or valleys having to create an uneven, rough, or non-uniform texture. The textured surface 300 can include a random texture or a patterned texture. For example, the textured surface 300 can include a pattern having certain shapes or lines (e.g., the pattern 800 or the pattern 900), a pattern that varies along at least one direction of the current collector (e.g., the pattern 600 or the pattern 700), some other pattern, or a combination thereof.

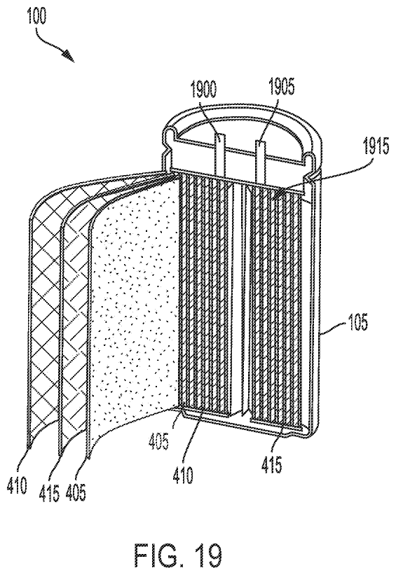

As noted above, the current collector 145 can be a current collector to couple an electrode tab 130 of an electrode 110 or an electrode stack tab (e.g., the electrode stack tab 1320 of an electrode stack 1300 shown in FIG. 13, among others) with a terminal (e.g., the terminal 1900 or 1905 as depicted in FIGS. 19-21, among others) of a battery cell 100, where the terminal can facilitate the electrical coupling of the battery cell 100 with another battery cell, with a busbar, or other electrical connector. The current collector 145 can also be another electrode tab 130 of another electrode 110 or another electrode stack tab (e.g., the electrode stack tab 1320 of another electrode stack 1300). The textured surface 300 of the current collector 145 can be a textured applied by an ultrasonic welding device (e.g., the ultrasonic device 1350 as depicted in FIG. 13, among others, and described below), with the current collector 145 being an electrode tab 130 of an electrode 110 or an electrode stack tab of an electrode stack.

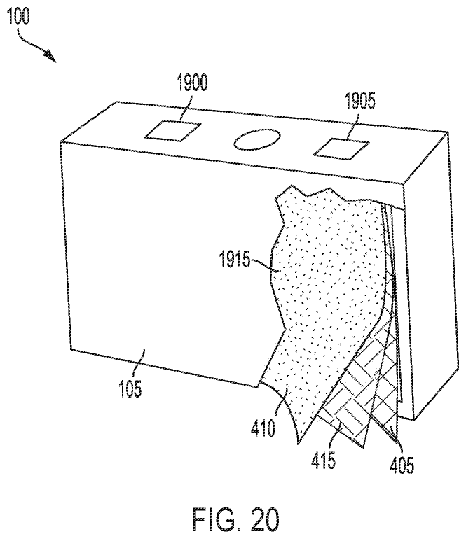

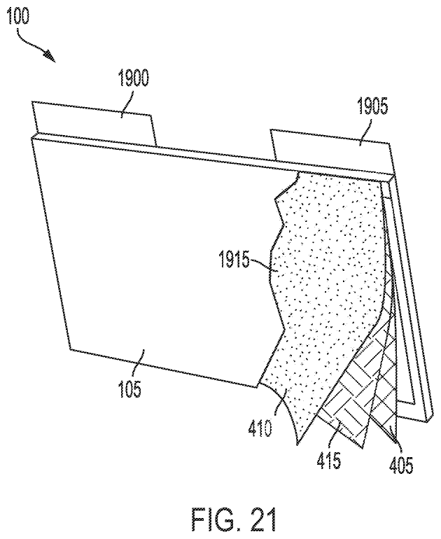

As depicted in FIG. 13, among others, an electrode stack 1300 can include multiple electrodes. The battery cell 100 can include the electrode stack 1300. For example, the battery cell 100 can include an electrode stack 1300 including multiple electrodes. The multiple electrodes can include at least one anode electrode (e.g., the electrodes 1305, 1307, 1309, or another anode electrode) and at least one cathode electrode (e.g., the cathode electrodes 1310, 1312, 1314, or another cathode electrode). The anode electrode 1305, 1307, 1309 can include an anode battery active material layer 115 applied to a copper electrically conductive foil layer 125 and a copper electrode tab 130. The cathode electrode 1310 can include a cathode battery active material layer 1325 applied to an aluminum electrically conductive foil layer 125 and an aluminum electrode tab 130. The electrode stack 1300 can include a first electrode tab 130, for example. The multiple electrodes 1305, 1307, 1309, 1310, 1312, and 1314 can be stacked to form an electrode layer stack 1300 for prismatic battery cells (e.g., the battery cell 100 depicted in FIG. 20, among others) or pouch battery cells (e.g., the battery cell depicted in FIG. 21, among others), or some other battery cell. The multiple electrodes 110 can be layered or wound to form a wound (e.g., rolled) electrode stack or jelly roll. For example, the electrode stack (e.g., a jelly roll) can be wound for cylindrical battery cells (e.g., the battery cell 100 depicted in FIG. 19, among others). The electrode stack 1300 can include multiple cathode electrodes (e.g., electrodes 1310, 1312, or 1314) layered in an alternating fashion with multiple anode electrodes (e.g., electrodes 1305, 1307, 1309). The electrode stack can include a separator layer 1315 (e.g., an electrolyte layer) provided in between adjacent electrodes 110 to separate the adjacent electrodes. The separator layer 1315 can be a solid-state electrolyte layer, a polymeric layer that can be subsequently wetted with a liquid electrolyte, or some other electrolyte layer, as is described below with reference to FIGS. 19-21.

The electrode stack 1300 can include multiple electrode tabs. For example, the electrode stack 1300 can include multiple electrode tabs, including the first electrode tab 130, at least one second electrode tab 1330, and at least one third electrode tab 1345. The number of electrode tabs can vary, and the number of electrode tabs shown in FIG. 13 is merely exemplary. For example, the electrode stack 1300 can include a first electrode tab 130, a second electrode tab 1330, and some number of third electrode tabs 1345 (e.g., one, two, six, twenty, or some other amount). The electrode stack 1300 can include at least fifty electrode tabs. For example, the electrode stack 1300 can include eighty electrode tabs 130, one hundred electrode tabs 130, more than one hundred electrode tabs 130, or some other number of electrode tabs 130. Each electrode tab 130 can be associated with one anode electrode (e.g., electrode 1305, 1307, or 1309) or one cathode electrode (e.g., electrode 1310, 1312, or 1314). For example, each electrode tab 130 can be associated with one cathode electrode 1310, 1312, 1314 or one anode electrode 1305, 1307, 1309 of an electrode stack 1300. The electrode tab (e.g., the tabs 130, 1330, and 1345) of the anode electrodes (e.g., electrodes 1305, 1307, and 1309) can be or include a copper material, for example. The electrode tabs of the cathode electrodes (e.g., electrodes 1310, 1312, and 1314) can be or include an aluminum material, for example. The electrode stack 1300 can include at least fifty electrode tabs 130, with twenty-five of the electrode tabs being anode electrode tabs and twenty-five of the electrode tabs being cathode electrode tabs.

The electrode stack 1300 can include the first electrode tab 130 and at least one additional electrode tab to form an electrode stack tab 1320. For example, the battery cell 100 can include the electrode stack 1300 including the electrode stack tab 1320 including the first electrode tab 130 joined with a second electrode tab. The battery cell 100 can include the first electrode tab 130 where the first electrode tab 130 can be one of electrode tabs of the electrode stack tab 1320. The battery cell 100 can include the electrode stack 1300 including a first electrically conductive foil joined with a second electrode tab 1330 to create the electrode stack tab 1320. For example, the battery cell 100 can include a first electrode having a first electrode tab and a second electrode having a second electrode tab. As depicted in FIG. 4, among others, the first electrode can be a first anode electrode 1305 including the first electrode tab 130. The second electrode can be the second anode electrode 1307 including the second electrode tab 1330. The second electrode tab 1330 can be joined with (e.g., welded with, adhered to, mechanically coupled with) the first electrode tab 130 to form the electrode stack tab 1320. The first electrode 1305 and the second electrode 1307 can include the same polarity (e.g., an anodic or cathodic polarity). For example and as depicted in FIG. 4, among others, the electrode stack 1300 can include multiple anode electrodes 1305, 1307, 1309 and multiple cathode electrodes 1310, 1312, 1314, as described above. The second electrode tab 1330 of the second anode electrode 1307 can be similar to or the same as the electrode tab 130 of the first electrode 1305 or that of the electrode 110 described above with reference to FIGS. 1-5, among others. The first electrode tab 130 and the second electrode tab 1330 can include the same or a similar material composition with both the first anode electrode 1305 and the second anode electrode 1307 being anode electrodes. For example, the first anode electrode 1305 can include a first electrode tab 130 that can be or include a copper material. The second anode electrode 1307 can include the second electrode tab 1330 that can be or include a copper material.

The electrode stack 1300 can include at least one additional electrode positioned between the first electrode and the second electrode. For example, the electrode stack 1300 can include a third electrode having the same polarity as the first electrode and the second electrode. As depicted in FIG. 4, among others, the electrode stack 1300 can include a third anode electrode 1309 positioned between the first anode electrode 1305 and the second anode electrode 1307 (with one or more of the cathode electrodes 1310, 1312, and 1314 also positioned therebetween). The third anode electrode 1309 can include a third electrode tab 1345. The third electrode tab 1345 can be joined with the first electrode tab 130 and the second electrode tab 1330 to form the electrode stack tab 1320. For example, the first electrode tab 130 of the electrode stack 1300 can be an uppermost electrode tab of the electrode stack tab 1320 (or the electrode stack 1300), the second electrode tab 1330 can be the lowermost electrode tab of the electrode stack tab 1320 (or the electrode stack 1300) with the third electrode tab 1345 positioned between the first electrode tab 130 and the second electrode tab 1330.

The tab 1320 can be electrically coupled with the current collector 145. For example, the tab 1320 can be laser welded with the current collector 145 with the laser welding device 210 as depicted in FIGS. 2-3, among others, and as described above. The laser welding device 210 can emit the laser 220 towards tab 1320 to create the joint 225, where the joint 225 joins the tab 1420 with the current collector 145. The joint 225 can be a welded joint that joins (e.g., mechanically couples, welds, fuses, or otherwise mates) the tab 1320 with the current collector 145. For example, the tab 1320 can be physically joined with the current collector 145 such that the current collector 145 cannot be separated from the tab 1320 without damaging or destroying one of the current collector 145 or the tab 1320. The joint 225 can include a melding, melting, combining, or blending of the current collector 145 with multiple electrode tabs (e.g., the first electrode tab 130, the second electrode tab 430, the third electrode tab 435, or some other electrode tab). For example, the laser 220 emitted by the laser element 215 of the laser welding device 210 can cause a portion the tab 1320 and a portion of the current collector 145 to melt and combine to form the joint 225. The laser 220 can include sufficient energy to cause at least a portion of the tab 1320 and at least a portion of the current collector 145 to melt, where the joint 225 can be formed via the melting of a portion of the tab 1320 and at least a portion of the current collector 145 with the tab 1320 against the current collector 145. For example, a lower most surface of the tab 1320 (e.g., the second electrode tab 430, the second textured surface 1340, or the second surface 1335) can be positioned against (e.g., abutting, contacting, or touching) the first surface 205 or some other surface of the current collector 145. A portion of the first surface 205 of the current collector 145 and a portion of the tab 1320 that is contacting (e.g., abutting, touching, positioned against) the first surface 205 can melt or partially melt to form the joint 225. The electrode stack tab 1320 can be electrically coupled with the current collector 145 with the current collector 145 having the textured surface 300 as depicted in FIG. 3, among others, and as discussed above.

The electrode stack 1300 can include first electrode tab ultrasonically welded with a second electrode tab to create the electrode stack tab 1320. For example, the first electrode tab can be the first electrode tab 130 of the first anode electrode 1305 as depicted in FIG. 4, among others. The second electrode tab can be the second electrode tab 1330 as depicted in FIG. 13, among others. The first electrode tab 130, the second electrode tab 1330, and any other electrode tabs (e.g., one or more electrode tabs, such as the third electrode tab 1345) positioned between the first electrode tab 130 and the second electrode tab 1330) can be ultrasonically welded together to form the electrode stack tab 1320.

As depicted in FIG. 13, among others, at least one ultrasonic welding device 1350 can include at least one vibrating member 1355 (e.g., a tip, a horn, a pad, a texturized pad, or other member) to move at an ultrasonic frequency. For example, the ultrasonic welding device 1350 can include the vibrating member 1355 to vibrate at an ultrasonic frequency (e.g., 20-40 kHz, less than 20 kHz, more than 40 kHz). The vibrating member 1355 can include a textured tip 1360. The vibrating member 1355 and can contact a surface with the textured tip 1360 to provide mechanical vibrations to the surface. For example, the vibrating member 1355 of the ultrasonic welding device 1350 can provide ultrasonic vibrations to an object that is clamped (e.g., held, retained) against an anvil or some stationary member. The vibrating member 1355 can apply a force against an object to ultrasonically weld the object to another object. For example, the vibrating member 1355 can contact an electrode tab (e.g., the first electrode tab 130) to impart mechanical vibrations to the electrode tab where the vibrating member 1355 can apply a force to the electrode tab (e.g., via a mass coupled with the vibrating member 1355 or by force of gravity acting on the vibrating member 1355 itself). The electrode tab can move, based on the imparted mechanical vibrations, relative to another object (e.g., another electrode tab, a current collector, or other object). For example, the first electrode tab 130 can vibrate relative to the third electrode tab 1345 or relative to the second electrode tab 1330 with the first electrode tab 130, the second electrode tab 1330, and the third electrode tab 1345 clamped (e.g., grouped, held) together. The movement of one object (e.g., the first electrode tab 130) relative to another object (e.g., the third electrode tab 1345 or the second electrode tab 1330) can cause at least one point of contact between the two objects to melt or can cause high-pressure dispersion of surface oxides from the objects to allow metal-to-metal contact between the objects to weld the objects together. For example, the ultrasonic welding device 1350 can provide mechanical vibrations to join (e.g., couple, ultrasonically weld) the first electrode tab 130 with the second electrode tab 1330 to form the electrode stack tab 1320.

The battery cell 100 can include the first electrode tab coupled with the second electrode tab to form the electrode stack tab 1320, where the electrode stack tab 1320 can be a unified structure. For example, the electrode tabs (e.g., electrode tabs 130, 1330, 1345) of the electrode stack tab 1320 can be coupled such that all of the electrode tabs collectively form the electrode stack tab 1320 as a unified structure. The electrode stack tab 1320 can include each electrode tab mechanically coupled with at least one adjacent electrode tab in a stack of electrode tabs. The electrode stack tab 1320 can include each electrode tab coupled with at least one adjacent electrode tab with no space (e.g., no air gap) between adjacent electrode tabs or with a small amount of space (e.g., less than one millimeter, less than one-half millimeter, or some other amount) between adjacent electrode tabs. For example, the electrode stack tab 1320 can include multiple electrode tabs coupled together where a thickness of the electrode stack tab 1320 is approximately equal to or slightly larger than (e.g., 10% larger than) a sum of the thicknesses of each individual electrode tab of the electrode stack tab 1320. The battery cell 100 can include the electrode stack tab 1320 created by ultrasonically welding the electrode tabs (e.g., the electrode tabs 130, 1330, 1345, or other electrode tabs) together can create a unified tab 1320 having no air gap between individual electrode tabs.

The electrode stack tab 1320 of the battery cell 100 can be coupled with the current collector 145 with the electrode tabs (e.g., electrode tabs 130, 1330, 1345, or other electrode tabs) ultrasonically welded to form the unified tab 1320 with no air gap (e.g., no space, less than one millimeter of space) between adjacent electrode tabs. For example, the electrode stack tab 1320 can include the electrode tabs ultrasonically joined (e.g., welded, coupled, mechanically integrated, or otherwise joined) to form a unified structure, where the unified tab 1320 is coupled with the current collector 145 to electrically couple the electrode stack tab 1320 or each of the electrode tabs with the current collector 145. The electrode stack tab 1320 can be coupled with (e.g., welded to, joined with) the current collector 145 without an apparatus to clamp or group the electrode tabs (e.g., the electrode tabs 130, 1330, 1345, or other electrode tabs) together. For example, in circumstances where the electrode stack tab 1320 is laser welded to the current collector 145 (e.g., as is described in further detail below), the electrode stack tab 1320 can be laser welded to the current collector 145 without using a window clamp or similar device to clamp individual electrode tabs into a position for the laser welding operation because the individual electrode tabs of the electrode stack tab 1320 can already be coupled (e.g., ultrasonically welded, mechanically joined, or otherwise coupled) to form a unified structure with no air gap between electrode tabs.

The battery cell 100 can include the electrode stack 1300 including the first electrode tab 130 as the uppermost electrode tab and the second electrode tab 1330 as the lowermost electrode tab. For example, the first electrode tab 130 can be an uppermost electrode tab of the electrode stack 1300. The first electrode tab 130 can be the uppermost electrode tab of the electrode stack tab 1320, where the electrode stack tab 1320 includes multiple electrode tabs stacked on top of each other or coupled with each other (e.g., ultrasonically welded together). The first electrode tab 130 can be the uppermost (e.g., outermost, top, first, last, end) electrode tab of the stack of electrode tabs in the electrode stack tab 1320 such that the first electrode tab 130 is exposed (e.g., visible, outward-facing accessible) on the stack, rather than being positioned between two electrode tabs. For example, the battery cell 100 can include an electrode stack 1300 including the first electrode tab 130 having the textured surface 135 as the uppermost surface of the electrode stack 1300. The textured surface 135 can be exposed (e.g., visible, outward-facing accessible) on the stack, rather than being positioned between two electrode tabs. The second electrode tab 1330 can be a lowermost electrode tab of the electrode stack 1300. The second electrode tab 1330 can be the lowermost electrode tab of the electrode stack tab 1320, where the electrode stack tab 1320 includes multiple electrode tabs stacked on top of each other or coupled with each other (e.g., ultrasonically welded together). The second electrode tab 1330 can be the lowermost (e.g., outermost, bottom, first, last, end) electrode tab of the stack of foils in the electrode stack tab 1320 such that the second electrode tab 130 is exposed (e.g., visible, outward-facing, accessible) on the stack, rather than being positioned between two electrode tabs.

The battery cell 100 can include the electrode stack 1300 including the second electrode tab 1330 including a second textured surface 1340. For example, the second electrode tab 1330 can be the lowermost electrode tab of the electrode stack 1300 or of the electrode stack tab 1320. A second surface 1335 can be a lower (e.g., outer, bottom) surface of the second electrode tab 1330 can be exposed (e.g., visible, outward-facing, accessible) on the stack, rather than being positioned between two electrode tabs. The second surface 1335 can include the textured surface 1340. The second textured surface 1340, like the textured surface 135, can be a portion of the second surface 1335 of the electrode tab 1330 that includes a surface texture that is rough relative to a remainder of the electrode tab 1330 or relative to the electrically conductive foil layer 125 from which the electrode tab 1330 extends. For example, the second textured surface 1340 can include a surface roughness (e.g., an Ra value, an average roughness) that is greater than a surface roughness of the foil layer 125 that has not been texturized. The foil layer 125 can be or include a shiny, smooth, substantially uniform (e.g., ±90% uniform) surface profile in absence of the second textured surface 1340. The textured surface 1340 can instead be or include a rough, matte, at least partially non-uniform surface. The second textured surface 1340 can include at least one peak 400, at least one valley 405, or at least one other feature to provide the surface roughness. For example, the second textured surface 1340 can include multiple peaks 400, multiple valleys 405, or multiple other features to create the second textured surface 1340 along a portion of the second surface 1335. The second textured surface 1340 can extend along a first direction (e.g., a length), a second direction (e.g., a width), or some other direction of the second electrode tab 1330. For example, the second textured surface 1340 can include at least one of the pattern 600, 700, 800, 900, 1000, 1100 or some other pattern, shape or feature as described above with respect to the textured surface 135. The second textured surface 1340 can be the lower most surface of the electrode stack 1300 or the electrode stack tab 1320 such that the second textured surface 1340 is exposed (e.g., visible, outward-facing, accessible). Each electrode tab (e.g., tab 130, 1330, 1345) of an electrode stack tab 1320 can include a textured surface (e.g., textured surface 135, 305, 1335, or some other textured surface). For example, a top surface of each electrode tab, a bottom surface of each electrode tab, the top and bottom surfaces of each electrode tab, or some other combination of surfaces of multiple electrode tabs can include a textured surface.

As depicted in FIG. 13, among others, the electrode stack 1300 (or the electrode 110) of the battery cell 100 can include the textured surface 135 of the first electrode tab 130 and the textured surface 1340 of the second electrode tab 130 created by ultrasonically welding the first electrode tab 130 with the second electrode tab 130. For example, the ultrasonic welding device 1350 can include the vibrating member 1355 having at least one textured tip 1360 (e.g., two textured tips 1360). The textured tip 1360 of the vibrating member 1355 can include at least one pattern (e.g., one or more of the patterns 600, 700, 800, 900, 1000, 1100, or other pattern), shape, or other feature. The vibrating member 1355 can create the textured surface 135 via the textured tip 1360 of the vibrating member 1355. For example, the vibrating member 1355 can impart a texture to create the textured surface 135 that matches or substantially matches (e.g., ±85% matches) the pattern(s), shape(s), or feature(s) of the textured tip of the vibrating member 1355. The textured tip 1360 of the vibrating member 1355 can be removable or replaceable such that the textured tip 1360 can be swapped or replaced with another textured tip 1360 in order to change a pattern of the textured surface 135. The ultrasonic welding device 1350 can include the vibrating member 1355 to move relative to the first surface 150 of the electrode tab 130 to create the textured surface 135. For example, at least one of the ultrasonic welding device 1350, the vibrating member 1355, or the electrode tab (s) to be ultrasonically welded can move so that a textured pattern (e.g., at least one of the pattern 600, 700, 800, 900, 1000, 1100, or another pattern) can be applied to or along multiple regions (e.g., areas, sections, portions) of the first surface 150 of the foil. At least one of the ultrasonic welding device 1350, the vibrating member 1355, or the foil(s) to be ultrasonically welded can move to create a curvilinear line for the pattern 900, for example. At least one of the ultrasonic welding device 1350, the vibrating member 1355, or the foil(s) to be ultrasonically welded can move in the first direction 605, the second direction 610, or some other direction along the first surface 150 of the foil (e.g., the electrode tab 130 or some other foil) to create a pattern 800 of overlapping shapes or other features, as depicted in FIG. 8, among others. The vibrating member 1355 can trace at least one pattern, shape, or other feature to create the textured surface 135. For example, the vibrating member 1355 can include a pointed tip to create a dot, line, or other small feature that, when applied to the first surface 150 of the electrode tab 130 along the first direction 605, the second direction 610, or some other direction, can create a pattern, shape, or other feature of the textured surface 135. The textured tip 1360 can impart a texture to the first surface 150 of the first electrode tab 130 and the surface 1335 of the second electrode tab 1330. For example, the textured tip 1360 can impart a texture to the surface 1335 of the second electrode tab 1330 through the first electrode tab 130 (e.g., by a single textured tip 1360 applying the texture to the first surface 150 that also creates a texture on the second electrode tab 1330 and any intervening foils). A second textured tip 1360 can create the textured surface 1340 of the second electrode tab 1330 by directly contacting the surface 1335 of the second electrode tab 1330.

The battery cell 100 can include a foil layer including a textured surface, where the foil layer can be notched to form the first electrode tab 130 including the textured surface 135. For example, the foil layer can be the electrically conductive foil layer 125 as depicted in FIGS. 1-3, among others. The electrically conductive foil layer 125 can be layer onto which the battery active material layer 115 is applied (e.g., coated, laminated, pressed, or otherwise adhered). The electrically conductive foil layer 125 can be notched (e.g., cut or trimmed) to form the electrode tab 130 that can extend from a side (e.g., the side 120) of the electrode 110, as depicted in FIG. 1, among others. The textured surface 135 can be applied to the electrically conductive foil layer 125 before the electrically conductive foil layer 125 is notched to form the electrode tab 130. For example, the textured surface 135 can be created before the electrode tab 130 is notched from the electrically conductive foil layer 125 such that a subsequent operation to texturize the electrode tab 130 to create the textured surface 135 (e.g., an ultrasonic welding operation) is not required or can be optional.

As depicted in FIG. 14, among others, the electrode 110 can be manufactured from an electrode layer 1420 (e.g., a web, a sheet, a film). For example, at a processing stage 1400, the battery active material layer 115 can be applied to (e.g., laminated with, coated on, pressed to, joined with, or otherwise adhered to) at least one surface of the electrically conductive foil layer 125. The battery active material layer 115 can be applied to the foil layer 125 with the battery active material in a wet, semi-wet, semi-dry, or dry form. For example, the battery active material layer 115 can be coated on the electrically conductive foil layer 125 as a wet or semi-wet material via a slot die coater or other coating device. The battery active material layer 115 can be laminated with the foil layer 125 with the battery active material layer 115 in a dry or semi-dry form. For example, the battery active material layer 115 can be a film that is created from a dry or semi-dry powder via a calendaring or calendar laminator system, where the film can be laminated with (e.g., adhered to) one or both sides of the foil layer 125 to create the electrode layer 1420. As depicted in FIG. 14, the electrode layer 1420 can include a first battery active material layer 115 on a first portion of the foil layer 125 and a second battery active material layer 115 on a second portion of the foil layer 125. The electrode layer 1420 can be a continuous layer (e.g., web, sheet, film) that can be rolled and transported to another operation or processed as a continuous sheet (e.g., pulled in a direction by at least one web handling device).

An uncoated portion of the foil layer 125 can exist on one or both sides of the battery active material layer 115. For example, the electrode layer 1420 can include a portion of the foil layer 125 on either side of the battery active material layer 115 that is not coated with, laminated with, or otherwise covered with the battery active material layer 115. The portion of the foil layer 125 that is not coated with the battery active material layer 115 can be texturized to create the textured surface 135. For example, the electrode layer 1420 can include a portion of the foil layer 125 that is not coated with the battery active material layer 115 including the textured surface 135 created by at least one laser device 1425. The laser device 1425 can micro-machine or etch the foil layer 125 to create the textured surface 135. For example, the laser device 1425 can be a femtolaser (e.g., a femtosecond laser) or a laser device that emits a high-energy laser beam in pulses (e.g., rapid pulses measured in femtoseconds or in trillionths of a second) towards the electrically conductive foil layer 125. The laser device 1425 can emit a laser beam having a wavelength of approximately 1053 nm or some other wavelength. The laser device 1425 can be an infrared laser device. The laser device 1425 can emit a pulse of laser light towards the uncoated portion of the foil layer 125 to etch, machine, texturize, ablate, or otherwise affect the foil layer 125 to create the textured surface 135. For example, the laser device 1425 can emit a pulse of laser light at an angle towards the foil layer 125 to create multiple peaks, valleys, or other surface features of the foil layer 125 that can result in the textured surface 135 as described above. The textured surface 135 created by the laser device 1425 can include any of the patterns 600, 700, 800, 900, 1000, 1100, or any other pattern. The textured surface 135 created by the laser device 1425 can cover a portion of the foil layer 125 (e.g., less than the entire uncoated portion), or the entire uncoated portion of the foil layer 125. Although the laser device 1425 is shown and described as creating the textured surface 135 to the electrode layer 1420 at processing stage 1400, the laser device 1425 can also create the textured surface 135 at some other processing stage, such as the processing stages 505, 510, or 515 as depicted in FIG. 5.

The textured surface 135 on the uncoated portion of the foil layer 125 can increase a bending stiffness of the foil layer 125. For example, a bending stiffness of the foil layer 125 can be greater with the foil layer 125 of the electrode layer 1420 including the textured surface 135 than without the foil layer 125 of the electrode layer 1420 including the textured surface 135. The foil layer 125 can include an increased resilience with the foil layer 125 including the textured surface 135. For example, the foil layer 125 can be less susceptible to bends, tears, rips, or other defects with the bending stiffness of the foil layer 125 increased by virtue of the textured surface 135. The electrode layer 1420 can be easier to manipulate or transport during subsequent operations or processes with the foil layer 125 having an increased bending stiffness and resilience. For example, the electrode layer 1420 can be processed to notch the foil layer 125 to create the electrode tab 130 or to singulate (e.g., cut, separate, trim) the electrode 110 from the electrode layer 1420 or another electrode layer (e.g., an electrode layer 1435) with a lesser risk of damage to the foil layer 125 because the textured surface 135 can increase the bending stiffness of the foil layer 125.

The electrode 110 can be manufactured by cutting the electrode layer 1420 to create the electrode layer 1435 shown at the processing stage 1405. For example, the electrode layer 1420 can include two or more sections of battery active material layer 115. At the processing stage 1405 or prior to the processing stage 1405 (e.g., at the processing stage 1400), the electrode layer 1420 can be cut or sectioned to create one or more electrode layers 535. For example, a laser device (e.g., a laser cutter), a mechanical blade, a blade coupled with a roller, or some other cutting device can cut the electrode layer 1420 along a sectioning line 1430 to create the electrode layer 1435. The electrode layer 1435 can include the battery active material layer 115 applied to the electrically conductive foil layer 125, with an uncoated portion of the electrically conductive foil layer 125 (e.g., a portion that does not have the battery active material layer 115 applied thereto) can extend to two sides of the electrode layer 1435. The foil layer 125 extending from the battery active material layer 115 can include the textured surface 135. The electrode layer 1435 can be a continuous layer (e.g., a web, sheet, or film) that can be rolled and transported to another operation or processed as a continuous sheet (e.g., pulled in a direction by at least one web handling device). At processing stage 1405, the electrode layer 1435 can be pressed (e.g., calendared or compressed) to form an electrode layer 1440. For example, the continuous electrode layer 1435 can be provided to a calendaring device (e.g., two or more rollers creating a pressure point or nip) to apply a pressure to the electrode layer 1435 to create the electrode layer 1440. The electrode layer 1440 can include the battery active material layer 115 including a desired density as a result of the pressing operation at processing stage 1405, for example.

At processing stage 1410, the electrode layer 1440 can be cut to form the electrode 110. For example, the electrode 110 can be manufactured by cutting the electrode layer 1440. The electrode layer 1440 can include the pressed battery active material layer 115 and an uncoated portion of the electrically conductive foil layer 125 extending to two sides of the battery active material layer 115. The electrode layer 1440 can be cut or sectioned to create the electrode 110, where the electrode 110 includes an uncoated portion of the foil layer 125 (e.g., the electrode tab 130) extending to only one side (e.g., the side 120) of the electrode 110, rather than extending from two sides. For example, a laser device (e.g., a laser cutter), a mechanical blade, a blade coupled with a roller, or some other cutting device can cut the electrode layer 1440 along a sectioning line 1445 to create at least one electrode 110. A laser device (e.g., a laser cutter), a mechanical blade, a blade coupled with a roller, or some other cutting device can cut the uncoated foil layer 125 of the electrode layer 1440 to create the electrode tab 130. For example, the uncoated foil layer 125 can be cut (e.g., notched or trimmed) to create the electrode tab 130 with the electrode tab 130 extending only to one side (e.g., the side 120) of the electrode 110. Cutting the foil layer 125 to form the electrode tab 130 can include removing at least one scrap portion 1450 of the foil layer 125 (e.g., a portion of the foil layer 125 that has been cut away from the electrode tab 130) from the electrode 110. For example, the electrode tab 130 can be extend along a portion of the side 120 of the electrode 110, rather than extending along the entire side 120.

The electrode layer 1440 can be cut to form a singulated (e.g., individual, single, isolated) electrode 110. For example, a laser device (e.g., a laser cutter), a mechanical blade, a blade coupled with a roller, or some other cutting device can cut the electrode layer 1440 to form the electrode 110, where the electrode 110 is not a continuous layer (e.g., web, sheet, film), but is instead a single or individual electrode 110 that can be stacked with other electrodes 110 to form the electrode stack 1300. For example, a singulated electrode 110 can result at processing stage 1415, where the singulated electrode 110 can be stacked with other electrode layers 110. The singulated electrode 110 can include the electrode tab 130 including the textured surface 135. For example, because the electrode 110 resulting at processing stage 1415 can include the textured surface 135, a subsequent texturizing operation (e.g., texturizing via an ultrasonic welding device) is not necessary or is optional. An increased bending stiffness of the electrode tab 130 can reduce a likelihood of the electrode tab 130 being bent, ripped, torn, or otherwise damaged as the electrode 110 is transported to another location for a stacking operation or as the electrode 110 is stacked to form the electrode stack 1300, thereby increasing throughput by decreasing scrap of an electrode manufacturing operation.

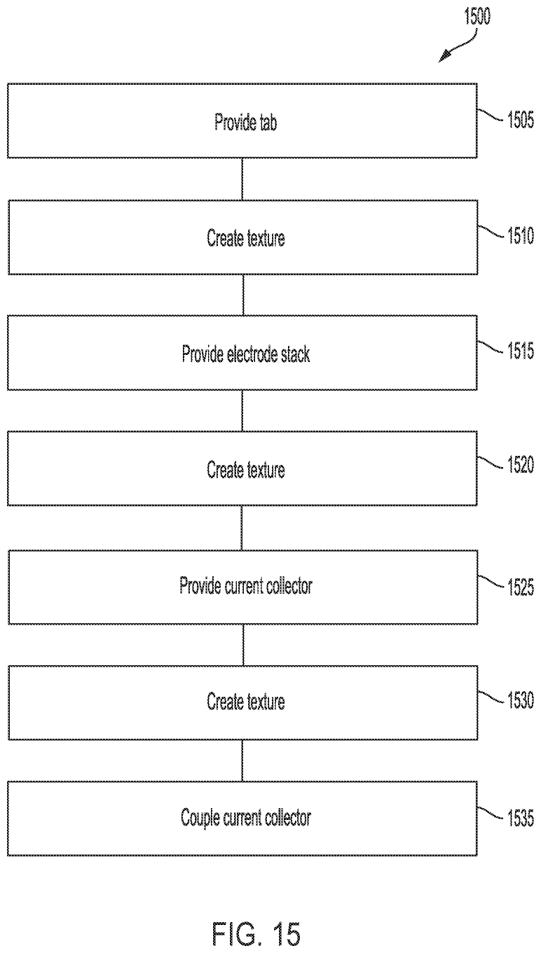

FIG. 15, among others, depicts a method 1500. The method 1500 can be a method of manufacturing a battery cell. For example, the method 1500 can be or include method of manufacturing a battery cell having the textured surface 135. The method 1500 can include one or more of ACTS 1505-1535. The method 1500 can include one or more of the ACTS 1505-1535 performed in any order.

The method 1500 can include providing an electrode tab at ACT 1505. The electrode tab 130 can be a portion of an electrically conductive foil layer 125 that extends to at least one side (e.g., the side 120) of the electrode 110. The electrode tab 130 can extend from the electrode 110 to electrically couple the electrode 110 with a current collector 145 or some other object (e.g., an electrode tab of another electrode). The electrode tab 130 can be or include a material corresponding to a polarity of the electrode 110. For example, the electrode 110 can be an anode electrode, such as the first anode electrode 1305. The electrode tab 130 can be or include a copper material with the electrode 110 being an anode electrode. The electrode 110 can be a cathode electrode, such as the cathode electrode 1310. The electrode tab 130 can be or include an aluminum material with the electrode 110 being a cathode electrode.

The method 1500 can include creating a texture at ACT 1510. For example, the method 1500 can include creating the textured surface 135 of the electrode tab 130 at ACT 1510. The textured surface 135 can be a portion of the first surface 150 of the electrode tab 130 that includes a surface texture that is rough relative to a remainder of the electrode tab 130 or relative to the electrically conductive foil layer 125. For example, the textured surface 135 can include a surface roughness (e.g., an Ra value, an average roughness) that is greater than a surface roughness of the foil layer 125 that has not been texturized. The foil layer 125 can be or include a shiny, smooth, substantially uniform (e.g., ±90% uniform) surface profile in absence of the textured surface 135. The textured surface 135 can instead be or include a rough, matte, at least partially non-uniform surface. The textured surface 135 can include at least one peak 400, at least one valley 405, or at least one other feature to provide the surface roughness. For example, the textured surface 300 can include multiple peaks 400, multiple valleys 405, or multiple other features to create the textured surface 300 along a portion of the surface 205. The textured surface 300 can extend along a first direction (e.g., a length), a second direction (e.g., a width), or some other direction of the current collector 145. For example, the textured surface 300 can include at least one of the pattern 600, 900, 1000, 1100, 1200, 1300 or some other pattern, shape or feature as described above with respect to the textured surface 135. The textured surface 300 can be the surface of the current collector 145 that contacts (e.g., couples against, abuts, touches, is joined with) the electrode tab 130 or the electrode stack tab 1320 with the electrode tab 130 or the electrode stack tab 1320 electrically coupled with the current collector 145. The textured surface 135 can include an increased surface area relative to an un-textured electrode tab. The increased surface area of the textured surface 135 can produce an increased a rate of heat dissipation at the electrode tab 130 relative to an un-textured electrode tab to improve a thermal behavior of the battery cell 100.

The textured surface 135 can be created by a micromachining operation, an ultrasonic welding operation, or some other operation. For example, the textured surface 135 can be created by an ultrasonic welding device 1350 having a vibrating member 1355, where the vibrating member 1355 contacts the electrode tab 130 to create mechanical vibrations. The vibrating member 1355 can include a texturized tip to create a pattern, shape, or other feature of the textured surface 135 with the vibrating member 1355 contacting the electrode tab 130. The textured surface 135 can be created by a micromachining operation or by a laser device, such as the laser device 1425. For example, the laser device 1425 can be a femtosecond laser device to emit a high-energy laser beam in pulses (e.g., rapid pulses measured in femtoseconds or in trillionths of a second) towards the electrically conductive foil layer 125 or the electrode tab 130. For example, the laser device 1425 can emit a pulse of laser light towards an uncoated portion of the foil layer 125 of an electrode layer (e.g., the electrode layer 1420) during manufacturing of the electrode 110 or towards the electrode tab 130 after the electrode tab 130 has been notched from the foil layer 125. The laser device 535 can emit a laser at the foil layer 125 or the electrode tab 130 to etch, machine, texturize, ablate, or otherwise affect the foil layer 125 to create the textured surface 135. The method 1500 can include creating the textured surface 135 with the electrode tab 130 not being joined with one or more other electrode tabs to form the electrode stack tab 1320.

The method 1500 can include providing an electrode stack at ACT 1515. For example, the method 1500 can include providing the electrode stack 1300 at ACT 1515. The electrode stack 1300 can include multiple electrode tabs, each associated with an electrode. For example, as depicted in FIG. 4, among others, the electrode stack 1300 can include at least one anode electrode 1305 and at least one cathode electrode 1310. The electrode stack 1300 can include the first anode electrode 1305, the second anode electrode 1307, and the third anode electrode 1309. The first anode electrode 1305 can include the first electrode tab 130, the second anode electrode 1307 can include the second electrode tab 1330, and the third anode electrode 1309 can include the third electrode tab 1345. The first electrode tab 130 can be joined with (e.g., coupled with, welded to, mechanically joined with) the second electrode tab 1330, the third electrode tab 1345, or one or more other electrode tabs to create the electrode stack tab 1320. For example, the electrode stack tab 1320 can include the first electrode tab 130 as an uppermost electrode tab and the second electrode tab 1330 as a lowermost electrode tab.

The method 1500 can include providing creating a texture at ACT 1520. For example, the method 1500 can include creating the textured surface 135 of the first electrode tab 130 or the second textured surface 1340 of the second electrode tab 1330 at ACT 1520. The textured surface 135 or the second textured surface 1340 can be created by ultrasonically welding the first electrode tab 130 with the second electrode tab 1330 to create the electrode stack tab 1320. For example, the ultrasonic welding device 1350 can include the vibrating member 1355 to contact the first electrode tab 130 or the second electrode tab 1330 with the first electrode tab 130 stacked with the second electrode tab 1330. The ultrasonic welding device 1350 can ultrasonically weld the first electrode tab 130 with the second electrode tab 1330 with the first electrode tab 130 and the second electrode tab 1330 can be grouped (e.g., clamped, held, retained) together. The ultrasonic welding device 1350 can contact the first electrode tab 130 or the second electrode tab 1330 with a textured tip 1360 of the vibrating member 1355 to create mechanical vibrations. The mechanical vibrations can cause high-pressure dispersion of surface oxides from the first electrode tab 130 or the second electrode tab 1330 to allow metal-to-metal contact between the first electrode tab 130 or the second electrode tab 1330 and an adjacent electrode tab to weld the electrode tabs 130 and 1330 together to form the electrode stack tab 1320. The vibrating member 1355 can impart a texture via the textured tip 1360 to create the textured surface 135 or the textured surface 1340. For example, the textured tip 1360 can impart a texture on the electrode tab 130 or the second electrode tab 1330 that matches or substantially matches (e.g., ±85% matches) the pattern(s), shape(s), or feature(s) of the textured tip 1360 of the vibrating member 1355.

The first electrode tab 130 can include the textured surface 135 with the textured surface being the uppermost (e.g., outward-facing, first, last, top) surface of the electrode stack tab 1320. The second electrode tab 1330 can include a second textured surface 1340 with the second textured surface 1340 being the lowermost (e.g., outward-facing, first, last, bottom) surface of the electrode stack tab 1320. For example, the two outermost surfaces of the electrode stack tab 1320 can include the textured surface 135 or the second textured surface 1340. In circumstances where the electrodes of the electrode stacks include electrode tabs that do not already include the textured surface 135 or another textured surface, the method 1500 can include creating the textured surface 135 or another textured surface at ACT 1520. For example, the first anode electrode 1305 or the second anode electrode 1307 can include the textured surface 135 or the second textured surface 1340, where the textured surface 135 or the second textured surface 1340 can be created by a micromachining or laser-etching operation at ACT 1510 before the electrode stack 1300 is created at ACT 1515. In such circumstances, ACT 1520 can be optional.

The method 1500 can include providing a current collector at ACT 1525. For example, the method 1500 can include providing the current collector 145 to electrically couple the electrode tab 130 or the electrode stack tab 1320 with the current collector 145 at ACT 1525. The current collector 145 can be an electrically conductive member within the housing 105 of the battery cell 100 that can facilitate an electrical connection between the electrode tab 130 or tab 1320 and another object (e.g., the terminal 1900 or the terminal 1905 as shown in FIGS. 19-21, among others or an electrically conductive member of another electrode or electrode stack). The current collector 145 can include a material composition that corresponds to a polarity of the electrode tab 130 or the electrode stack tab 1320. For example, the current collector 145 can be or include a copper material with the current collector 145 coupled with one or more anode electrodes 110 (e.g., an electrode 110 including an anodic battery active material 115, a copper electrically conductive foil layer 125, and a copper electrode tab 130). The current collector 145 can be or include an aluminum material with the current collector 145 coupled with one or more cathode electrodes 110 (e.g., an electrode 110 including a cathodic battery active material 115, an aluminum electrically conductive foil layer 125, and an aluminum electrode tab 130).

The method 1500 can include creating a texture at ACT 1530. For example, the method 1500 can include creating a textured surface 300 of the current collector 145 at ACT 1530. The textured surface 300 can include a surface roughness (e.g., an Ra value, an average roughness) that is greater than a surface roughness of the current collector 145 that has not been texturized. For example, the current collector 145 can be or include a shiny, smooth, substantially uniform (e.g., ±90% uniform) surface profile in absence of the textured surface 300. The textured surface 300 can instead be or include a rough, matte, at least partially non-uniform surface. The textured surface 300 can include at least one peak 400, at least one valley 405, or at least one other feature to provide the surface roughness. For example, the textured surface 300 can include multiple peaks 400, multiple valleys 405, or multiple other features to create the textured surface 300 along a portion of the surface 205. The textured surface 300 can extend along a first direction (e.g., a length), a second direction (e.g., a width), or some other direction of the current collector 145. For example, the textured surface 300 can include at least one of the pattern 600, 900, 1000, 1100, 1200, 1300 or some other pattern, shape or feature as described above with respect to the textured surface 135. The textured surface 300 can be the surface of the current collector 145 that contacts (e.g., couples against, abuts, touches, is joined with) the electrode tab 130 or the electrode stack tab 1320 with the electrode tab 130 or the electrode stack tab 1320 electrically coupled with the current collector 145. The textured surface 300 can be created by a micromachining operation, a laser-etching operation, an ultrasonic welding operation, or another operation. For example, the textured surface 300 can be created by the laser device 1425 or the ultrasonic welding device 1350.

The method 1500 can include coupling the current collector at ACT 1535. For example, method 1500 can include electrically coupling the electrode tab 130 or the electrode stack tab 1320 with the current collector 145 at ACT 1535. The electrode stack tab 1320 can include the first electrode tab 130 and can be laser welded with the current collector 145 to electrically couple the first electrode tab 130 with the current collector 145. For example, the electrode tab 130 or the electrode stack tab 1320 can be laser welded to the current collector 145 by at least one laser welding device 210. The electrode stack tab 1320 can include the second textured surface 1340 as the lowermost surface of the electrode stack tab 1320. The second textured surface 1340 or an un-textured surface of the second electrode tab 1330 can contact (e.g., abut, touch, be positioned against) a surface of the current collector 145, such as the textured surface 300. The textured surface 135 can be exposed (e.g., visible, outward-facing, accessible) with the current collector 145 positioned against the electrode stack tab 1320. The laser welding device 210 can emit the laser 220 towards the electrode tab 130 or the electrode stack tab 1320 to create a joint 225. The joint 225 can be a welded joint that joins (e.g., mechanically couples, welds, fuses, or otherwise mates) the electrode tab 130 or the electrode stack tab 1320 with the current collector 145 with a surface of the current collector 145 (e.g., the textured surface 300) against a surface (e.g., the second textured surface 1340) of the electrode stack tab 1320. The textured surface 135 can increase an absorption of the laser 220 into the electrode tab 130, the electrode stack tab 1320, or the current collector 145 by reducing a reflection of the laser 220. The textured surface 135 can increase the absorption of the laser 220 to increase a strength of the joint 225. The textured surface 135 can reduce spatter during a laser welding operation by increasing absorption of the laser 220 to reduce an energy requirement of the laser welding device 210.

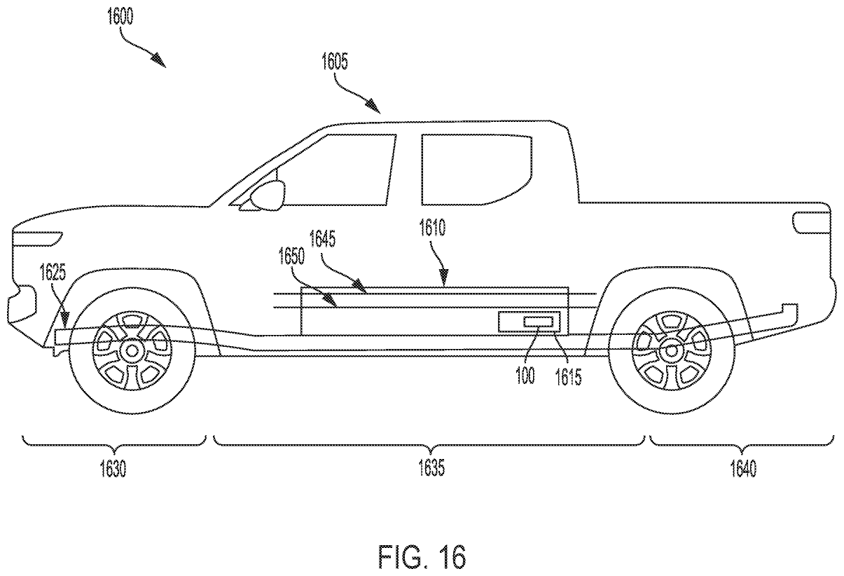

FIG. 16 depicts an example cross-sectional view 1600 of an electric vehicle 1605 installed with at least one battery pack 1610. Electric vehicles 1605 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 1610 can also be used as an energy storage system to power a building, such as a residential home or commercial building. Electric vehicles 1605 can be fully electric or partially electric (e.g., plug-in hybrid) and further, electric vehicles 1605 can be fully autonomous, partially autonomous, or unmanned. Electric vehicles 1605 can also be human operated or non-autonomous. Electric vehicles 1605 such as electric trucks or automobiles can include on-board battery packs 1610, batteries 1615 or battery modules 1615, or battery cells 100 to power the electric vehicles. The electric vehicle 1605 can include a chassis 1625 (e.g., a frame, internal frame, or support structure). The chassis 1625 can support various components of the electric vehicle 1605. The chassis 1625 can span a front portion 1630 (e.g., a hood or bonnet portion), a body portion 1635, and a rear portion 1640 (e.g., a trunk, payload, or boot portion) of the electric vehicle 1605. The battery pack 1610 can be installed or placed within the electric vehicle 1605. For example, the battery pack 1610 can be installed on the chassis 1625 of the electric vehicle 1605 within one or more of the front portion 1630, the body portion 1635, or the rear portion 1640. The battery pack 1610 can include or connect with at least one busbar, e.g., a current collector element. For example, the first busbar 1645 and the second busbar 1650 can include electrically conductive material to connect or otherwise electrically couple the battery 1615, the battery modules 1615, or the battery cells 100 with other electrical components of the electric vehicle 1605 to provide electrical power to various systems or components of the electric vehicle 1605.

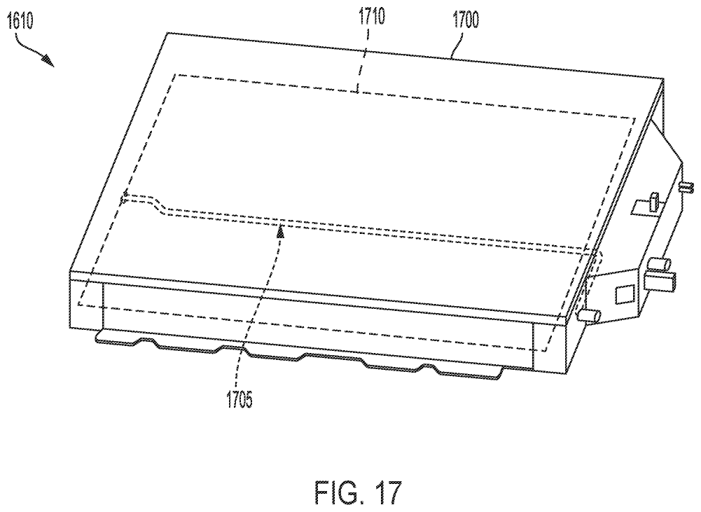

FIG. 17 depicts an example battery pack 1610. Referring to FIG. 17, among others, the battery pack 1610 can provide power to electric vehicle 1605. Battery packs 1610 can include any arrangement or network of electrical, electronic, mechanical or electromechanical devices to power a vehicle of any type, such as the electric vehicle 1605. The battery pack 1610 can include at least one housing 1700. The housing 1700 can include at least one battery module 1615 or at least one battery cell 100, as well as other battery pack components. The battery module 1615 can be or can include one or more groups of prismatic cells, cylindrical cells, pouch cells, or other form factors of battery cells 100. The housing 1700 can include a shield on the bottom or underneath the battery module 1615 to protect the battery module 1615 and/or cells 100 from external conditions, for example if the electric vehicle 1605 is driven over rough terrains (e.g., off-road, trenches, rocks, etc.) The battery pack 1610 can include at least one cooling line 1705 that can distribute fluid through the battery pack 1610 as part of a thermal/temperature control or heat exchange system that can also include at least one thermal component (e.g., cold plate) 1710. The thermal component 1710 can be positioned in relation to a top submodule and a bottom submodule, such as in between the top and bottom submodules, among other possibilities. The battery pack 1610 can include any number of thermal components 1710. For example, there can be one or more thermal components 1710 per battery pack 1610, or per battery module 1615. At least one cooling line 1705 can be coupled with, part of, or independent from the thermal component 1710.

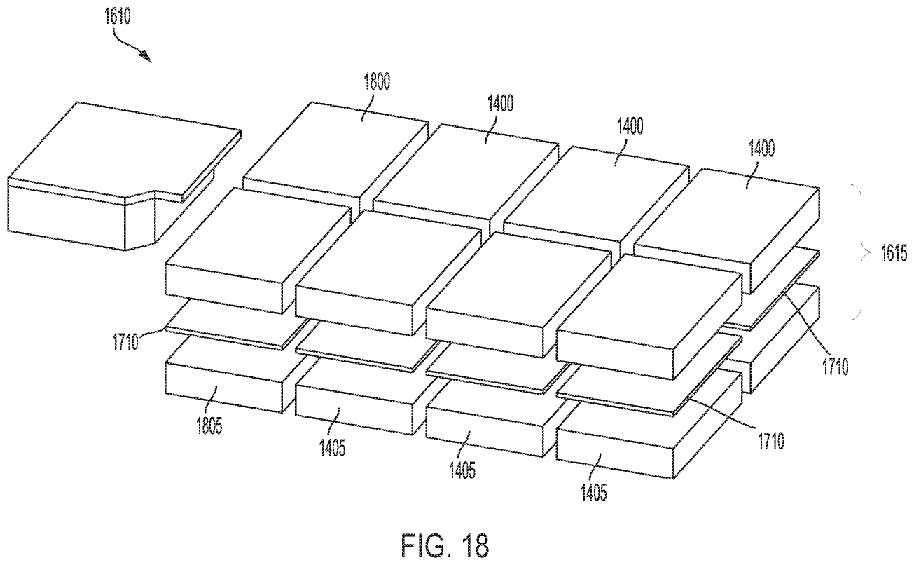

FIG. 18 depicts example battery modules 1615, and FIGS. 19-21 depict an example cross sectional view of a battery cell 100. The battery modules 1615 can include at least one submodule. For example, the battery modules 1615 can include at least one first (e.g., top) submodule 1800 or at least one second (e.g., bottom) submodule 1805. At least one thermal component 1710 can be disposed between the top submodule 1800 and the bottom submodule 1805. For example, one thermal component 1710 can be configured for heat exchange with one battery module 1615. The thermal component 1710 can be disposed or thermally coupled between the top submodule 1800 and the bottom submodule 1805. One thermal component 1710 can also be thermally coupled with more than one battery module 1615 (or more than two submodules 1800, 1805). The thermal components 1710 shown adjacent to each other can be combined into a single thermal component 1710 that spans the size of one or more submodules 1800 or 1805. The thermal component 1710 can be positioned underneath submodule 1800 and over submodule 1805, in between submodules 1800 and 1805, on one or more sides of submodules 1800, 1805, among other possibilities. The thermal component 1710 can be disposed in sidewalls, cross members, structural beams, among various other components of the battery pack, such as battery pack 1610 described above. The battery submodules 1800, 1805 can collectively form one battery module 1615. In some examples each submodule 1800, 1805 can be considered as a complete battery module 1615, rather than a submodule.

The battery modules 1615 can each include a plurality of battery cells 100. The battery modules 1615 can be disposed within the housing 1700 of the battery pack 1610. The battery modules 1615 can include battery cells 100 that are cylindrical cells or prismatic cells, for example. The battery module 1615 can operate as a modular unit of battery cells 100. For example, a battery module 1615 can collect current or electrical power from the battery cells 100 that are included in the battery module 1615 and can provide the current or electrical power as output from the battery pack 1610. The battery pack 1610 can include any number of battery modules 1615. For example, the battery pack can have one, two, three, four, five, six, seven, eight, nine, ten, eleven, twelve or other number of battery modules 1615 disposed in the housing 1700. It should also be noted that each battery module 1615 may include a top submodule 1800 and a bottom submodule 1805, possibly with a thermal component 1710 in between the top submodule 1800 and the bottom submodule 1805. The battery pack 1610 can include or define a plurality of areas for positioning of the battery module 1615 and/or cells 100. The battery modules 1615 can be square, rectangular, circular, triangular, symmetrical, or asymmetrical. In some examples, battery modules 1615 may be different shapes, such that some battery modules 1615 are rectangular but other battery modules 1615 are square shaped, among other possibilities. The battery module 1615 can include or define a plurality of slots, holders, or containers for a plurality of battery cells 100. It should be noted the illustrations and descriptions herein are provided for example purposes and should not be interpreted as limiting. For example, the battery cells 100 can be inserted in the battery pack 1610 without battery modules 1800 and 1805. The battery cells 100 can be disposed in the battery pack 1610 in a cell-to-pack configuration without modules 1800 and 1805, among other possibilities.

Battery cells 100 have a variety of form factors, shapes, or sizes. For example, battery cells 100 can have a cylindrical, rectangular, square, cubic, flat, pouch, elongated or prismatic form factor. As depicted in FIG. 19, for example, the battery cell 100 can be cylindrical. As depicted in FIG. 20, for example, the battery cell 100 can be prismatic. As depicted in FIG. 21, for example, the battery cell 100 can include a pouch form factor. Battery cells 100 can be assembled, for example, by inserting a winded or stacked electrode roll (e.g., a jelly roll) including electrolyte material into at least one battery cell housing 105. The electrolyte material, e.g., an ionically conductive fluid or other material, can support electrochemical reactions at the electrodes to generate, store, or provide electric power for the battery cell by allowing for the conduction of ions between a positive electrode and a negative electrode. The battery cell 100 can include an electrolyte layer where the electrolyte layer can be or include solid electrolyte material that can conduct ions. For example, the solid electrolyte layer can conduct ions without receiving a separate liquid electrolyte material. The electrolyte material, e.g., an ionically conductive fluid or other material, can support conduction of ions between electrodes to generate or provide electric power for the battery cell 100.

The housing 105 can be of various shapes, including cylindrical or rectangular, for example. The housing 105 can be a structural housing. For example, the battery cell 100 can include the housing 105 with the housing 105 as an assembly of a plurality of structural members. For example, the housing 105 can include a hollow can, a faceplate, a sidewall, a ring, a cap, or another rigid or flexible member that can be assembled to form the housing 105. The housing 105 can protect the electrode layer stack 1300 from damage (e.g., surface defects, blemishes, rips, tears, occlusions, or other defects) that can be introduced by collision of the vehicle (e.g., a side-impact collision) with some other object. The housing 105 can include a first faceplate and a second faceplate that are coupled with a structural ring. The housing 105 can be an assembly of at least one sidewall, at least one faceplate, at least one ring, at least one hollow structure, or other components. The housing 105 can be a structural housing 105 for a cell-to-pack configuration where the battery pack 1610 can include structural battery cells 100 (e.g., battery cells 100 including the structural housing 105). The housing 105 of the structural battery cell 100 can include a structural member (e.g., a ring, a face plate, a side wall, or some other member) to bolster a rigidity of the battery cell 100 so that the battery cell 100 can be a structural, rigid, and resilient structure to withstand forces (e.g., static or dynamic forces) that may occur with the battery cell 100 within the battery pack 1610 in a cell-to-pack configuration.

Electrical connections can be made between the electrolyte material and components of the battery cell 100. For example, electrical connections to the electrodes with at least some of the electrolyte material can be formed at two points or areas of the battery cell 100, for example to form a first polarity terminal 1900 (e.g., a positive or anode terminal) and a second polarity terminal 1905 (e.g., a negative or cathode terminal). The polarity terminals can be made from electrically conductive materials to carry electrical current from the battery cell 100 to an electrical load, such as a component or system of the electric vehicle 1605.

For example, the battery cell 100 can include at least one lithium-ion battery cell. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 100 to separate the anode and cathode from each other and to facilitate transfer of lithium ions between the anode and cathode. It should be noted that battery cell 100 can also take the form of a solid state battery cell developed using solid electrodes and solid electrolytes. Solid electrodes or electrolytes can be or include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B=Al, Ti), garnet-type with formula A₃B₂(XO₄)₃ (A=Ca, Sr, Ba and X=Nb, Ta), lithium phosphorous oxy-nitride (LiₓPO_{y}N₂). In some embodiments, the solid electrolyte layer can include a glassy, ceramic and/or crystalline sulfide-based electrolyte (e.g., Li₃PS₄, Li₂P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂S₁₂) and/or sulfide-based lithium argyrodites with formula Li₆PS₅X (X=Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

The battery cell 100 can be included in battery modules 1615 or battery packs 1610 to power components of the electric vehicle 1605. The battery cell housing 105 can be disposed in the battery module 1615, the battery pack 1610, or a battery array installed in the electric vehicle 1605. The housing 105 can be of any shape, such as cylindrical with a circular (e.g., as depicted in FIG. 19, among others), elliptical, or ovular base, among others. The shape of the housing 105 can also be prismatic with a polygonal base, as shown in FIG. 20, among others. As shown in FIG. 21, among others, the housing 105 can include a pouch form factor. The housing 105 can include other form factors, such as a triangle, a square, a rectangle, a pentagon, and a hexagon, among others. In some embodiments, the battery pack may not include modules (e.g., module-free). For example, the battery pack can have a module-free or cell-to-pack configuration where the battery cells are arranged directly into a battery pack without assembly into a module.

The housing 105 of the battery cell 100 can include one or more materials with various electrical conductivity or thermal conductivity, or a combination thereof. The electrically conductive and thermally conductive material for the housing 105 of the battery cell 100 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 105 of the battery cell 100 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others. In examples where the housing 105 of the battery cell 100 is prismatic (e.g., as depicted in FIG. 20, among others) or cylindrical (e.g., as depicted in FIG. 19, among others), the housing 105 can include a rigid or semi-rigid material such that the housing 105 is rigid or semi-rigid (e.g., not easily deformed or manipulated into another shape or form factor). In examples where the housing 105 includes a pouch form factor (e.g., as depicted in FIG. 21, among others), the housing 105 can include a flexible, malleable, or non-rigid material such that the housing 105 can be bent, deformed, manipulated into another form factor or shape.

The battery cell 100 can include at least one anode layer 1910, which can be disposed within the cavity 1915 defined by the housing 105. The anode layer 1910 can include a first redox potential. The anode layer 1910 can receive electrical current into the battery cell 100 and output electrons during the operation of the battery cell 100 (e.g., charging or discharging of the battery cell 100). The anode layer 1910 can include an active substance. The active substance can include, for example, an activated carbon or a material infused with conductive materials (e.g., artificial or natural graphite, or blended), lithium titanate (Li₄Ti₅O₁₂), or a silicon-based material (e.g., silicon metal, oxide, carbide, pre-lithiated), or other lithium alloy anodes (Li—Mg. Li—Al, Li—Ag alloy etc.) or composite anodes consisting of lithium and carbon, silicon and carbon or other compounds. The active substance can include graphitic carbon (e.g., ordered or disordered carbon with sp² hybridization), Li metal anode, or a silicon-based carbon composite anode, or other lithium alloy anodes (Li—Mg, Li—Al, Li—Ag alloy etc.) or composite anodes consisting of lithium and carbon, silicon and carbon or other compounds. In some examples, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell does not comprise an anode active material in an uncharged state.

The battery cell 100 can include at least one cathode layer 1920 (e.g., a composite cathode layer compound cathode layer, a compound cathode, a composite cathode, or a cathode). The cathode layer 1920 can include a second redox potential that can be different than the first redox potential of the anode layer 1910. The cathode layer 1920 can be disposed within the cavity 1915. The cathode layer 1920 can output electrical current out from the battery cell 100 and can receive electrons during the discharging of the battery cell 100. The cathode layer 1920 can also receive lithium ions during the discharging of the battery cell 100. Conversely, the cathode layer 1920 can receive electrical current into the battery cell 100 and can output electrons during the charging of the battery cell 100. The cathode layer 1920 can release lithium ions during the charging of the battery cell 100.

The battery cell 100 can include an electrolyte layer 1925 disposed within the cavity 1915. The electrolyte layer 1925 can be arranged between the anode layer 1910 and the cathode layer 1920 to separate the anode layer 1910 and the cathode layer 1920. A separator can be wetted with a liquid electrolyte. The liquid electrolyte can be diffused into the anode layer 1910. The liquid electrolyte can be diffused into the cathode layer 1920. The electrolyte layer 1925 can help transfer ions between the anode layer 1910 and the cathode layer 1920. The electrolyte layer 1925 can transfer Li⁺ cations from the anode layer 1910 to the cathode layer 1920 during the discharge operation of the battery cell 100. The electrolyte layer 1925 can transfer lithium ions from the cathode layer 1920 to the anode layer 1910 during the charge operation of the battery cell 100.

The redox potential of layers (e.g., the first redox potential of the anode layer 1910 or the second redox potential of the cathode layer 1920) can vary based on a chemistry of the respective layer or a chemistry of the battery cell 100. For example, lithium-ion batteries can include an LFP (lithium iron phosphate) chemistry, an LMFP (lithium manganese iron phosphate) chemistry, an NMC (Nickel Manganese Cobalt) chemistry, an NCA (Nickel Cobalt Aluminum) chemistry, an OLO (Over Lithiated Oxide) chemistry, or an LCO (lithium cobalt oxide) chemistry for a cathode layer (e.g., the cathode layer 1920). Lithium-ion batteries can include a graphite chemistry, a silicon-graphite chemistry, or a lithium metal chemistry for the anode layer (e.g., the anode layer 1910).

For example, lithium-ion batteries can include an olivine phosphate (LiMPO₄, M=Fe and/or Co and/or Mn and/or Ni)) chemistry, LISICON or NASICON Phosphates (Li₃M₂(PO₄)₃ and LiMPO₄Oₓ, M=Ti, V, Mn, Cr, and Zr), for example Lithium iron phosphate (LFP), Lithium iron manganese phosphate (LMFP), layered oxides (LiMO₂, M=Ni and/or Co and/or Mn and/or Fe and/or Al and/or Mg) examples, NMC (Nickel Manganese Cobalt) chemistry, an NCA (Nickel Cobalt Aluminum) chemistry, or an LCO (lithium cobalt oxide) chemistry for a cathode layer, Lithium rich layer oxides (Li₁₊ₓM₁₋ₓO₂) (Ni, and/or Mn, and/or Co), (OLO or LMR), spinel (LiMn₂O₄) and high voltage spinels (LiMn_{1.5}Ni_{0.5}O₄), disordered rock salt, Fluorophosphates Li₂FePO₄F (M=Fe, Co, Ni) and Fluorosulfates LiMSO₄F (M=Co, Ni, Mn) (e.g., the cathode layer 1920). Lithium-ion batteries can include a graphite chemistry, a silicon-graphite chemistry, or a lithium metal chemistry for the anode layer (e.g., the anode layer 1910). For example, a cathode layer having an LFP chemistry can have a redox potential of 3.4 V vs. Li/Lit, while an anode layer having a graphite chemistry can have a 0.2 V vs. Li/Li⁺ redox potential.

Electrode layers can include anode active material or cathode active material, commonly in addition to a conductive carbon material, a binder, or other additives as a coating on a current collector (e.g., the electrically conductive foil layer 125 or some other metal foil). The chemical composition of the electrode layers can affect the redox potential of the electrode layers. For example, cathode layers (e.g., the cathode layer 1920) can include medium to high-nickel content (50 to 80%, or equal to 80% Ni) lithium transition metal oxide, such as a particulate lithium nickel manganese cobalt oxide (“LiNMC”), a lithium nickel cobalt aluminum oxide (“LiNCA”), a lithium nickel manganese cobalt aluminum oxide (“LiNMCA”), or lithium metal phosphates like lithium iron phosphate (“LFP”) and lithium iron manganese phosphate (“LMFP”). Anode layers (e.g., the anode layer 1910) can include conductive carbon materials such as graphite, carbon black, carbon nanotubes, and the like. Anode layers can include Super P carbon black material, Ketjen Black, Acetylene Black, SWCNT, MWCNT, graphite, carbon nanofiber, or graphene, for example.

Electrode layers can also include chemical binding materials (e.g., binders). Binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Binder materials can include agar-agar, alginate, amylose, Arabic gum, carrageenan, cascine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA). poly(vinyl acetate) (PVAc), polyacrylonitrile (PAN), polyisoprene (PIpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

Current collector materials (e.g., the electrically conductive foil layer 125 to which an electrode active material is laminated to form a cathode layer or an anode layer) can include a metal material. For example, current collector materials can include aluminum, copper, nickel, titanium, stainless steel, or carbonaceous materials. The current collector material can be formed as a metal foil. For example, the current collector material can be an aluminum (Al) or copper (Cu) foil. The current collector material can be a metal alloy, made of Al, Cu, Ni, Fe, Ti, or combination thereof. The current collector material can be a metal foil coated with a carbon material, such as carbon-coated aluminum foil, carbon-coated copper foil, or other carbon-coated foil material.

The electrolyte layer 1925 can include or be made of a liquid electrolyte material. For example, the electrolyte layer 1925 can be or include at least one layer of polymeric material (e.g., polypropylene, polyethylene, or other material) that is wetted (e.g., is saturated with, is soaked with, receives) a liquid electrolyte substance. The liquid electrolyte material can include a lithium salt dissolved in a solvent. The lithium salt for the liquid electrolyte material for the electrolyte layer 1925 can include, for example, lithium tetrafluoroborate (LiBF₄), lithium hexafluorophosphate (LiPF₆), and lithium perchlorate (LiClO₄), among others. The solvent can include, for example, dimethyl carbonate (DMC), ethylene carbonate (EC), and diethyl carbonate (DEC), among others. The electrolyte layer 1925 can include or be made of a solid electrolyte material, such as a ceramic electrolyte material, polymer electrolyte material, or a glassy electrolyte material, or among others, or any combination thereof.

In some embodiments, the solid electrolyte film can include at least one layer of a solid electrolyte. Solid electrolyte materials of the solid electrolyte layer can include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B=Al, Ti), garnet-type with formula A₃B₂(XO₄)₃ (A=Ca, Sr, Ba and X=Nb, Ta), lithium phosphorous oxy-nitride (LiₓPO_{y}N_{z}). In some embodiments, the solid electrolyte layer can include a glassy, ceramic and/or crystalline sulfide-based electrolyte (e.g., Li₃PS₄, Li₂P₃S₁₁, Li₂S—P₂S₅, Li_{z}S—B₂S₃, SnS—P₂S₅, Li₂S—SiS₂, Li₂S—P₂S₅, Li₂S—GeS₂, Li₁₀GeP₂S₁₂) and/or sulfide-based lithium argyrodites with formula Li₆PS₅X (X=Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

In examples where the electrolyte layer 1925 includes a liquid electrolyte material, the electrolyte layer 1925 can include a non-aqueous polar solvent. The non-aqueous polar solvent can include a carbonate such as ethylene carbonate, propylene carbonate, diethyl carbonate, ethyl methyl carbonate, dimethyl carbonate, or a mixture of any two or more thereof. The electrolyte layer 1925 can include at least one additive. The additives can be or include vinylidene carbonate, fluoroethylene carbonate, ethyl propionate, methyl propionate, methyl acetate, ethyl acetate, or a mixture of any two or more thereof. The electrolyte layer 1925 can include a lithium salt material. For example, the lithium salt can be lithium perchlorate, lithium hexafluorophosphate, lithium bis(fluorosulfonyl)imide, lithium bis(trifluorosulfonyl)imide, or a mixture of any two or more thereof. The lithium salt may be present in the electrolyte layer 1925 from greater than 0 M to about 1.5 M.

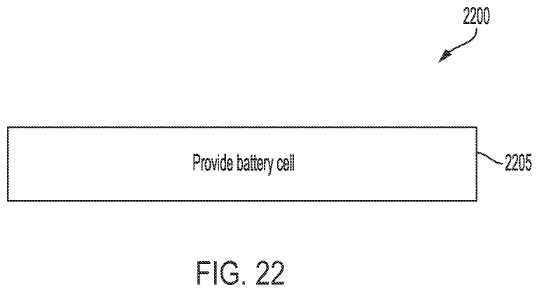

FIG. 22, among others, depicts a method 2200. The method 2200 can include providing a battery cell at ACT 2205. The battery cell can be the battery cell 100. For example, the battery cell 100 can include at least one electrode (e.g., the electrode 110, the first anode electrode 1305, or another electrode). The electrode can include an electrode tab 130 extending from the electrode to electrically couple the electrode with another object (e.g., a current collector 145). The battery cell 100 can include multiple electrodes, each having an electrode tab where the multiple electrode tabs are joined together to form a tab 1320. The electrode stack tab 1320 can be electrically coupled with the current collector 145. The electrode stack tab 1320 can include the electrode tab 130 as the uppermost electrode tab. The electrode tab 130 or the electrode stack tab 1320 including the electrode tab 130 can be laser welded with the current collector 145 to electrically couple the current collector 145 with the electrode tab 130. The electrode tab 130 can include a textured surface 135. The textured surface 135 can include a surface roughness (e.g., an Ra value, an average roughness value) that is greater than a surface roughness of an electrode tab not having the textured surface 135. The textured surface 135 can include the textured surface to facilitate an electrical coupling of the current collector 145 with the electrode tab 130. For example, the textured surface can increase an absorption of a laser 220 of a laser welding device 210 into the electrode tab 130, the electrode stack tab 1320, or the current collector 145 by reducing a reflection of the laser 220. The textured surface 135 can increase the absorption of the laser 220 to increase a strength of a joint 225 between the electrode tab 130 and the current collector 145. The textured surface 135 can reduce spatter during a laser welding operation by increasing absorption of the laser 220 to reduce an energy requirement of the laser welding device 210.

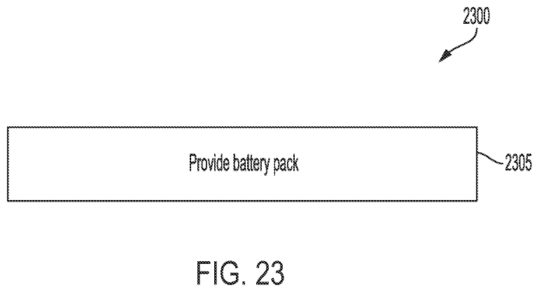

FIG. 23, among others, depicts a method 2300. The method 2300 can include providing a battery pack at ACT 2305. The battery pack can be the battery pack 1610. The battery pack 1610 can include a battery cell, such as the battery cell 100. The battery cell 100 can include at least one electrode (e.g., the electrode 110, the first anode electrode 1305, or another electrode). The electrode can include an electrode tab 130 extending from the electrode to electrically couple the electrode with another object (e.g., a current collector 145, a battery cell terminal, another electrode stack). The battery cell 100 can include multiple electrodes, each having an electrode tab where the multiple electrode tabs are joined together to form a tab 1320. The electrode stack tab 1320 can be electrically coupled with the current collector 145. The electrode stack tab 1320 can include the electrode tab 130 as the uppermost electrode tab. The electrode tab 130 or the electrode stack tab 1320 including the electrode tab 130 can be laser welded with the current collector 145 to electrically couple the current collector 145 with the electrode tab 130. The electrode tab 130 can include a textured surface 135. The textured surface 135 can include a surface roughness (e.g., an Ra value, an average roughness value) that is greater than a surface roughness of an electrode tab not having the textured surface 135. The textured surface 135 can include the textured surface to facilitate an electrical coupling of the current collector 145 with the electrode tab 130. For example, the textured surface can increase an absorption of a laser 220 of a laser welding device 210 into the electrode tab 130, the electrode stack tab 1320, or the current collector 145 by reducing a reflection of the laser 220. The textured surface 135 can increase the absorption of the laser 220 to increase a strength of a joint 225 between the electrode tab 130 and the current collector 145. The textured surface 135 can reduce spatter during a laser welding operation by increasing absorption of the laser 220 to reduce an energy requirement of the laser welding device 210.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A battery cell, comprising:
a current collector; and
a first electrode tab having a textured surface, the first electrode tab electrically coupled with the current collector.

2. The battery cell of claim 1, comprising:
an electrode stack including the first electrode tab.

3. The battery cell of claim 1, comprising:
an electrode stack having a plurality of electrode tabs, including the first electrode tab, the first electrode tab having the textured surface being an uppermost electrode tab in the electrode stack.

4. The battery cell of claim 1, comprising:
an electrode stack having a plurality of electrode tabs, including the first electrode tab, the plurality of electrode tabs including at least fifty electrode tabs.

5. The battery cell of claim 1, comprising:
an electrode stack having a plurality of electrode tabs, including the first electrode tab and a second electrode tab, the first electrode tab having a first textured surface being an uppermost surface in the electrode stack and the second electrode tab having a second textured surface being a lowermost surface in the electrode stack.

6. The battery cell of claim 1, comprising:
an electrode stack having a plurality of electrode tabs, including the first electrode tab and a second electrode tab, the first electrode tab having a first textured surface being an uppermost surface in the electrode stack and the second electrode tab having a second textured surface being a lowermost surface in the electrode stack; and
the current collector having a third textured surface in contact with the second textured surface.

7. The battery cell of claim 1, comprising:
an electrode stack including an electrode stack tab, the electrode stack tab comprising the first electrode tab joined with a second electrode tab to electrically couple the first electrode tab with the current collector.

8. The battery cell of claim 1, comprising:
an electrode stack including an electrode stack tab joined with the current collector, the electrode stack tab including the first electrode tab joined with a second electrode tab; and
the current collector including a second textured surface, the second textured surface to engage with the second electrode tab with the electrode stack tab joined with the current collector.

9. The battery cell of claim 1, comprising:
the textured surface including a pattern having a dimension that varies along a direction of the first electrode tab.

10. The battery cell of claim 1, comprising:
the textured surface including a pattern having a dimension that varies along a first direction and a second direction of the first electrode tab.

11. The battery cell of claim 1, comprising:
the textured surface including a pattern having a plurality of circles overlapping in a first direction.

12. The battery cell of claim 1, comprising:
the textured surface including a pattern having a plurality of curvilinear lines.

13. The battery cell of claim 1, comprising:
the first electrode tab including a first surface, a portion of the first surface including the textured surface and a remaining portion of the first surface including an un-textured surface.

14. A method, comprising:
providing a first electrode tab having a textured surface; and
electrically coupling the first electrode tab to a current collector.

15. The method of claim 14, comprising:
creating the textured surface on the first electrode tab by ultrasonically welding the first electrode tab with a second electrode tab.

16. The method of claim 14, comprising:
providing an electrode stack comprising the first electrode tab, an uppermost surface of the electrode stack including the textured surface of the first electrode tab.

17. The method of claim 14, comprising:
providing an electrode stack comprising a plurality of electrode tabs including the first electrode tab and a second electrode tab, the first electrode tab having a first textured surface being an uppermost electrode tab in the electrode stack and the second electrode tab having a second textured surface being a lowermost electrode tab in the electrode stack.

18. The method of claim 14, comprising:
creating the textured surface on the first electrode tab by creating a second textured surface on a foil layer; and
notching the foil layer having the second textured surface to form the first electrode tab including the textured surface.

19. A structural battery pack, comprising:
a plurality of battery cells, each battery cell comprising:
a structural member; and
a first electrode tab including a textured surface, the first electrode tab at least partially enclosed by the structural member.

20. The structural battery pack of claim 19, comprising:
an electrode stack of the battery cell comprising a plurality of electrode tabs including the first electrode tab and a second electrode tab, the first electrode tab having a first textured surface being an uppermost electrode tab in the electrode stack and the second electrode tab having a second textured surface being a lowermost electrode tab in the electrode stack.
